(19) United States
(12) Patent Application Publication
(10) Pub. No.: US 2025/0343572 A1
(43) Pub. Date: Nov. 6, 2025

(54) PRIORITIZING AN ENERGY REQUEST OR DATA TRANSMISSIONS FOR ENERGY HARVESTING PROCEDURES

(71) Applicant: QUALCOMM INCORPORATED, San Diego, CA (US)

(72) Inventors: Ahmed Elshafie, San Diego, CA (US); Seyedkianoush Hosseini, San Diego, CA (US); Yuchul Kim, San Diego, CA (US); Zhikun Wu, Beijing (CN); Jing Lei, San Diego, CA (US); Linhai He, San Diego, CA (US); Huilin Xu, Temecula, CA (US)

(21) Appl. No.: 18/866,036

(22) PCT Filed: Aug. 1, 2022
(86) PCT No.: PCT/CN2022/109372

§ 371 Date: Nov. 14, 2024

(51) Int. Cl. H04B 5/79; H02J 50/00; H02J 50/20; H02J 50/40; H04W 72/12

(52) U.S. Cl. CPC H04B 5/79; H02J 50/001; H02J 50/20; H02J 50/40; H04W 72/12

(57) ABSTRACT

Methods, systems, and devices for wireless communications are described. An energy transmitting user equipment (UE) may determine to perform a plurality of transmissions, each transmission of the plurality of transmissions comprising a data transmission, an energy transmission to charge an energy receiving device in response to a request, or both. The UE may select, based on an energy threshold and one or more parameters for prioritizing the transmissions, one or more transmissions of the plurality of transmissions to perform. For example, a network entity may transmit the one or more parameters to the energy transmitting UE for prioritizing the transmissions at the energy transmitting UE. The UE may transmit the data transmission, the energy transmission to charge the energy receiving device, or both corresponding to the selection.

### CROSS REFERENCE

The present Application is a 371 national stage filing of International PCT Application No. PCT/CN2022/109372 by Elshafie et al. entitled “PRIORITIZING AN ENERGY REQUEST OR DATA TRANSMISSIONS FOR ENERGY HARVESTING PROCEDURES,” filed Aug. 1, 2022, which is assigned to the assignee hereof, and which is expressly incorporated by reference in its entirety herein.

### FIELD OF TECHNOLOGY

The following relates to wireless communications, including prioritizing an energy request or data transmissions for energy harvesting (EH) procedures.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some wireless communications systems, a UE may perform multiple transmissions, which may include energy transmissions to an energy receiving device in an energy harvesting (EH) procedure, data transmissions to a network entity, or both. In some examples, however, the UE may be unable to prioritize the transmissions and may be unable to determine the order in which to perform the transmissions.

### SUMMARY

The described techniques relate to improved methods, systems, devices, and apparatuses that support prioritizing an energy request or data transmissions for energy harvesting (EH) procedures. Generally, the described techniques provide for a user equipment (UE) (e.g., an energy transmitting UE) to prioritize a data transmission to a network entity, an energy transmission to charge an energy receiving device, or both, based on prioritization parameters from the network entity. For example, the energy transmitting UE may receive control signaling from the network entity to perform the data transmission, requests from energy receiving devices to perform the energy transmission, or both. The energy transmitting UE may operate according to an energy threshold, such that the UE may have a finite quantity of energy to perform the transmissions. The energy transmitting UE may select and perform the transmissions based on the energy threshold and on the prioritization parameters.

A method for wireless communication at an energy transmitting UE is described. The method may include determining that the energy transmitting UE is to perform a set of multiple transmissions, each transmission of the set of multiple transmissions including a data transmission, an energy transmission to charge an energy receiving device in response to a request from the energy receiving device, or both, selecting, based on an energy threshold and one or more parameters for prioritizing the set of multiple transmissions, one or more transmissions of the set of multiple transmissions to perform, and transmitting the data transmission, the energy transmission to charge the energy receiving device, or both corresponding to the selection.

An apparatus for wireless communication at an energy transmitting UE is described. The apparatus may include a processor, memory coupled with the processor, and instructions stored in the memory. The instructions may be executable by the processor to cause the apparatus to determine that the energy transmitting UE is to perform a set of multiple transmissions, each transmission of the set of multiple transmissions including a data transmission, an energy transmission to charge an energy receiving device in response to a request from the energy receiving device, or both, select, based on an energy threshold and one or more parameters for prioritizing the set of multiple transmissions, one or more transmissions of the set of multiple transmissions to perform, and transmit the data transmission, the energy transmission to charge the energy receiving device, or both corresponding to the selection.

Another apparatus for wireless communication at an energy transmitting UE is described. The apparatus may include means for determining that the energy transmitting UE is to perform a set of multiple transmissions, each transmission of the set of multiple transmissions including a data transmission, an energy transmission to charge an energy receiving device in response to a request from the energy receiving device, or both, means for selecting, based on an energy threshold and one or more parameters for prioritizing the set of multiple transmissions, one or more transmissions of the set of multiple transmissions to perform, and means for transmitting the data transmission, the energy transmission to charge the energy receiving device, or both corresponding to the selection.

A non-transitory computer-readable medium storing code for wireless communication at an energy transmitting UE is described. The code may include instructions executable by a processor to determine that the energy transmitting UE is to perform a set of multiple transmissions, each transmission of the set of multiple transmissions including a data transmission, an energy transmission to charge an energy receiving device in response to a request from the energy receiving device, or both, select, based on an energy threshold and one or more parameters for prioritizing the set of multiple transmissions, one or more transmissions of the set of multiple transmissions to perform, and transmit the data transmission, the energy transmission to charge the energy receiving device, or both corresponding to the selection.

In some examples of the method, apparatuses, and non-transitory computer-readable medium described herein, selecting the one or more transmissions may include operations, features, means, or instructions for receiving the request from the energy receiving device, the request indicating the one or more parameters of the energy receiving device, determining a priority level of the request based on the one or more parameters of the energy receiving device, and selecting the energy transmission to charge the energy receiving device based on the priority level of the request satisfying a priority level threshold.

Some examples of the method, apparatuses, and non-transitory computer-readable medium described herein may further include operations, features, means, or instructions for receiving control signaling indicating for the energy transmitting UE to prioritize the set of multiple transmissions according to a first time of arrival of the request, where the one or more parameters include the time of arrival of the request.

In some examples of the method, apparatuses, and non-transitory computer-readable medium described herein, selecting the one or more transmissions may include operations, features, means, or instructions for selecting the energy transmission to charge the energy receiving device based on the time of arrival of the request being before another time of arrival of a second request from a second energy receiving device.

In some examples of the method, apparatuses, and non-transitory computer-readable medium described herein, selecting the one or more transmissions may include operations, features, means, or instructions for selecting the energy transmission to charge the energy receiving device, the data transmission, or both based on the time of arrival of the request satisfying a threshold time of arrival and selecting the data transmission based on the time of arrival of the request failing to satisfy a threshold time of arrival.

In some examples of the method, apparatuses, and non-transitory computer-readable medium described herein, selecting the one or more transmissions may include operations, features, means, or instructions for receiving an indication of a first priority of data at the energy receiving device, selecting the one or more transmissions based on comparing the first priority of the data at the energy receiving device and a second priority of the data transmission, where the selecting includes, selecting the energy transmission to charge the energy receiving device based on the first priority being greater than the second priority in accordance with the comparing, and selecting the data transmission based on the second priority being greater than the first priority in accordance with the comparing.

In some examples of the method, apparatuses, and non-transitory computer-readable medium described herein, selecting the one or more transmissions may include operations, features, means, or instructions for receiving control signaling indicating for the energy transmitting UE to prioritize the data transmission, where the control signaling includes the one or more parameters and selecting the data transmission to perform based on the control signaling.

In some examples of the method, apparatuses, and non-transitory computer-readable medium described herein, selecting the one or more transmissions may include operations, features, means, or instructions for receiving control signaling indicating for the energy transmitting UE to prioritize the data transmission, the energy transmission to charge the energy receiving device, or both, according to a prioritization schedule in a time-domain, wherein the one or more parameters comprise the prioritization schedule in the time-domain and selecting, at an instance in the time-domain, the one or more transmissions of the set of multiple transmissions to perform based on the prioritization schedule.

Some examples of the method, apparatuses, and non-transitory computer-readable medium described herein may further include operations, features, means, or instructions for receiving, from a network entity, control signaling indicating the one or more parameters, the energy threshold, or both.

Some examples of the method, apparatuses, and non-transitory computer-readable medium described herein may further include operations, features, means, or instructions for determining that transmitting the data transmission or the energy transmission (e.g., signaling) to charge the energy receiving device corresponds to a first energy value less than the energy threshold and transmitting additional energy transmission to charge an additional energy receiving device based on the energy value being less than the energy threshold, the additional signaling corresponding to a second energy value including a difference between the first energy value and the energy threshold.

In some examples of the method, apparatuses, and non-transitory computer-readable medium described herein, the one or more parameters include a priority of data at the energy receiving device, a remaining packet delay budget of the energy receiving device, a UE class, an energy state of the energy receiving device, a time of arrival of the request, or any combination thereof.

In some examples of the method, apparatuses, and non-transitory computer-readable medium described herein, the UE class indicates a minimum or default charging rate of the energy receiving device, a minimum or default discharge rate of the energy receiving device, a data rate of the energy receiving device, a charging technique of the energy receiving device, a harvesting architecture of the energy receiving device, a capability to harvest radio frequency energy from one or more of frequency bands, a capability to harvest from different type of EH technologies, an application monitored by the energy receiving device, or any combination thereof.

In some examples of the method, apparatuses, and non-transitory computer-readable medium described herein, the energy transmission includes a repetition of the data transmission.

A method for wireless communication at a network entity is described. The method may include determining that an energy transmitting UE is to perform a set of multiple transmissions, each transmission of the set of multiple transmissions including a data transmission, an energy transmission to charge an energy receiving device in response to a request from the energy receiving device, or both and transmitting, to the energy transmitting UE and based on an energy threshold of the energy transmitting UE, one or more parameters for prioritizing the set of multiple transmissions at the energy transmitting UE.

An apparatus for wireless communication at a network entity is described. The apparatus may include a processor, memory coupled with the processor, and instructions stored in the memory. The instructions may be executable by the processor to cause the apparatus to determine that an energy transmitting UE is to perform a set of multiple transmissions, each transmission of the set of multiple transmissions including a data transmission, an energy transmission to charge an energy receiving device in response to a request from the energy receiving device, or both and transmit, to the energy transmitting UE and based on an energy threshold of the energy transmitting UE, one or more parameters for prioritizing the set of multiple transmissions at the energy transmitting UE.

Another apparatus for wireless communication at a network entity is described. The apparatus may include means for determining that an energy transmitting UE is to perform a set of multiple transmissions, each transmission of the set of multiple transmissions including a data transmission, an energy transmission to charge an energy receiving device in response to a request from the energy receiving device, or both and means for transmitting, to the energy transmitting UE and based on an energy threshold of the energy transmitting UE, one or more parameters for prioritizing the set of multiple transmissions at the energy transmitting UE.

A non-transitory computer-readable medium storing code for wireless communication at a network entity is described. The code may include instructions executable by a processor to determine that an energy transmitting UE is to perform a set of multiple transmissions, each transmission of the set of multiple transmissions including a data transmission, an energy transmission to charge an energy receiving device in response to a request from the energy receiving device, or both and transmit, to the energy transmitting UE and based on an energy threshold of the energy transmitting UE, one or more parameters for prioritizing the set of multiple transmissions at the energy transmitting UE.

Some examples of the method, apparatuses, and non-transitory computer-readable medium described herein may further include operations, features, means, or instructions for transmitting control signaling indicating for the energy transmitting UE to prioritize the set of multiple transmissions according to a first time of arrival of the request, where the one or more parameters include the time of arrival of the request.

Some examples of the method, apparatuses, and non-transitory computer-readable medium described herein may further include operations, features, means, or instructions for transmitting control signaling indicating for the energy transmitting UE to prioritize the data transmission, where the control signaling includes the one or more parameters.

Some examples of the method, apparatuses, and non-transitory computer-readable medium described herein may further include operations, features, means, or instructions for transmitting control signaling indicating for the energy transmitting UE to prioritize the data transmission, the energy transmission to charge the energy receiving device, or both, according to a prioritization schedule in a time-domain, wherein the one or more parameters comprise the prioritization schedule in the time-domain.

Some examples of the method, apparatuses, and non-transitory computer-readable medium described herein may further include operations, features, means, or instructions for transmitting, to the energy transmitting UE, control signaling indicating the one or more parameters, the energy threshold, or both.

In some examples of the method, apparatuses, and non-transitory computer-readable medium described herein, the one or more parameters include a priority of data at the energy receiving device, a remaining packet delay budget of the energy receiving device, a UE class, an energy state of the energy receiving device, a time of arrival of the request, or any combination thereof.

In some examples of the method, apparatuses, and non-transitory computer-readable medium described herein, the UE class indicates a minimum or default charging rate of the energy receiving device, a minimum or default discharge rate of the energy receiving device, a data rate of the energy receiving device, a charging technique of the energy receiving device, a harvesting architecture of the energy receiving device, a capability to harvest radio frequency energy from one or more of frequency bands, a capability to harvest from different type of EH technologies, an application monitored by the energy receiving device, or any combination thereof.

### BRIEF DESCRIPTION OF THE DRAWINGS

FIG. 1 illustrates an example of a wireless communications system that supports prioritizing an energy request or data transmissions for energy harvesting (EH) procedures in accordance with one or more aspects of the present disclosure.

FIG. 2 illustrates an example of a wireless communications system that supports prioritizing an energy request or data transmissions for EH procedures in accordance with one or more aspects of the present disclosure.

FIG. 3 illustrates an example of an energy transmission scheme that supports prioritizing an energy request or data transmissions for EH procedures in accordance with one or more aspects of the present disclosure.

FIG. 4 illustrates an example of a process flow that supports prioritizing an energy request or data transmissions for EH procedures in accordance with one or more aspects of the present disclosure.

FIGS. 5 and 6 show block diagrams of devices that support prioritizing an energy request or data transmissions for EH procedures in accordance with one or more aspects of the present disclosure.

FIG. 7 shows a block diagram of a communications manager that supports prioritizing an energy request or data transmissions for EH procedures in accordance with one or more aspects of the present disclosure.

FIG. 8 shows a diagram of a system including a device that supports prioritizing an energy request or data transmissions for EH procedures in accordance with one or more aspects of the present disclosure.

FIGS. 9 and 10 show block diagrams of devices that support prioritizing an energy request or data transmissions for EH procedures in accordance with one or more aspects of the present disclosure.

FIG. 11 shows a block diagram of a communications manager that supports prioritizing an energy request or data transmissions for EH procedures in accordance with one or more aspects of the present disclosure.

FIG. 12 shows a diagram of a system including a device that supports prioritizing an energy request or data transmissions for EH procedures in accordance with one or more aspects of the present disclosure.

FIGS. 13 through 16 show flowcharts illustrating methods that support prioritizing an energy request or data transmissions for EH procedures in accordance with one or more aspects of the present disclosure.

### DETAILED DESCRIPTION

In some wireless communications systems, a user equipment (UE) may use energy harvesting (EH) procedures to harvest energy from various sources, such as radio frequency (RF) sources. In some examples, an energy transmitting (e.g., charging) UE may transmit signaling (e.g., RF waves) to an energy receiving (e.g., energy requesting) device to charge the energy receiving device for communications. The energy transmitting UE may use a finite quantity of energy and one or more time-frequency resources for signaling to charge energy receiving devices and one or more different time-frequency resources for transmitting or receiving control signaling or data. However, the energy transmitting UE may be unable to determine an overall priority for charging energy receiving devices, performing data transmission and reception, or both, during the one or more time-frequency resources. The inability of the energy transmitting UE to prioritize the transmissions, receptions, or both may result in increased latency for data communications and inefficient use of energy at the energy transmitting UE related to the EH procedures.

The features described herein generally relate to an energy transmitting UE prioritizing a data transmission from the energy transmitting UE, signaling to charge an energy receiving device, or both according to one or more prioritization parameters. For example, the energy transmitting UE may receive instructions to perform the data transmission, one or more requests from energy receiving devices to perform the signaling, or both. The energy transmitting UE may operate according to an energy threshold, such that the energy transmitting UE may have a finite quantity of energy to perform multiple transmissions. The energy transmitting UE may select one or more of the multiple transmissions to perform based on the energy threshold and on the one or more prioritization parameters.

In some examples, the transmission prioritization parameters may include a priority of a data at the energy receiving device, a remaining packet delay budget (PDB) of the highest priority data packet to be received or transmitted by the energy receiving device, a UE class, an energy state of the energy receiving device, a time of arrival of the requests, or any combination thereof. In some cases, the energy transmitting UE may prioritize charging an energy receiving UE over a different energy receiving UE based on the prioritization parameters, may prioritize a data transmission over charging an energy receiving UE based on the prioritization parameters, may prioritize the charging request and/or the data transmission according to a first-in-first-out (FIFO) manner based on the prioritization parameters, or any combination thereof. The energy transmitting UE may transmit the selected transmissions, such as signaling to the energy receiving device, a data transmission to a network entity or another UE, or both.

Aspects of the disclosure are initially described in the context of wireless communications systems. Aspects of the disclosure are further illustrated and described by an energy transmission scheme and a process flow. Aspects of the disclosure are further illustrated by and described with reference to apparatus diagrams, system diagrams, and flowcharts that relate to prioritizing an energy request or data transmissions for EH procedures.

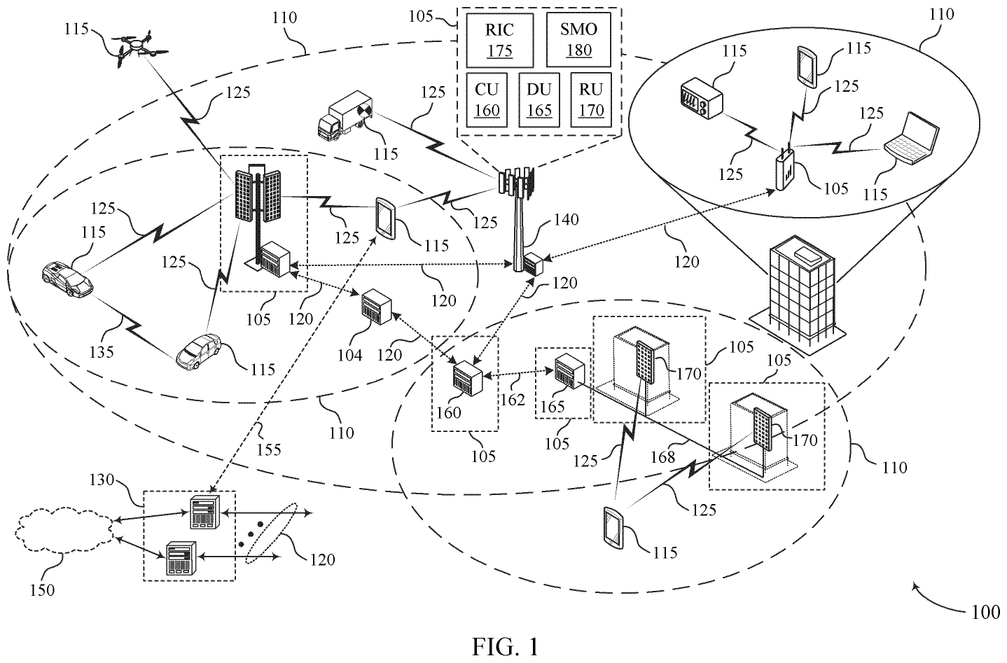

FIG. 1 illustrates an example of a wireless communications system 100 that supports prioritizing an energy request or data transmissions for EH procedures in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a RF access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support prioritizing an energy request or data transmissions for EH procedures as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving.” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and Ne may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrow band IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

The wireless communications system 100 may be configured to support EH procedures to harvest energy from various sources (solar, vibration, thermal, RF sources, etc.). The wireless communications system 100 may use the EH devices, which may include energy receiving devices (e.g., zero power devices, passive IoT devices, or the like), for power sourcing, security, access control, managing connectivity, positioning, tracking, identification, sensing, or any combination thereof. One or more devices of the wireless communications procedure may be involved in the EH procedures (e.g., EH Enabled Communication Services (EHECS)), such as passive IoT devices. Passive IoT devices may be used to collect data, but the devices may not independently have power to transmit the data to other devices, such as a network entity 105. For example, the passive IoT devices may be battery-less or may have limited energy storage (e.g., the devices may use a capacitor to store energy). As such, passive IoT devices may be low cost and may utilize a relatively small quantity of power (e.g., less than 100 microwatts (uW)). In some examples, passive IoT devices may include RF identification (RFID) sensors, and the RFID sensors may use RF power to locate (identify, track, sense, etc.) RFID tags attached to objects. In some cases, RF EH devices, such as an energy transmitting UE 115, may transmit power (e.g., an energy signal) to an RFID tag, and the RFID tag may transmit (e.g., backscatter) data (data with a priority, quality of service (QOS), etc.) using the energy signal from the RF EH device. In this example, the energy transmitting UE 115 may be able to transmit energy to (e.g., charge) an energy receiving device (e.g., an RFID tag).

There may be multiple energy transmitting UEs 115 and energy receiving UEs 115 (e.g., charging UEs 115) in the wireless communications system 100. In some cases, multiple EH devices, such as energy receiving devices, may request energy transmissions (e.g., power signaling or charging signaling) from energy transmitting UEs 115 to (e.g., charge) the energy receiving devices, which may result in conflicts between the energy transmitting UE 115 transmitting data to a network entity 105, receiving data from a network entity 105, or transmitting energy to an energy receiving device. The energy transmitting UE 115 may use one or more time-frequency resources for signaling to charge energy receiving devices and one or more different time-frequency resource for transmitting or receiving control signaling or data. If an energy level falls below a threshold for the communications at an energy receiving device, the energy receiving device may transmit an energy request to an energy transmitting UE 115.

However, the energy transmitting UEs 115 may be unable to determine an overall priority for charging energy receiving devices, performing data transmission and reception, or both during the one or more time-frequency resources (e.g., priority of data vs data, data vs energy, or energy vs energy requests), which may result in increased latency for data communications and inefficient use of energy at the energy transmitting UE 115 (e.g., charging UE 115) related to the EH procedures. For example, an energy transmitting UE 115 may receive multiple energy requests from energy receiving devices, and the energy transmitting UE 115 may be unable to determine an order to charge the energy receiving devices, as the priority of the energy receiving devices may not be clearly defined. In some other examples, the energy transmitting UE 115 may be configured to perform a transmission or reception, but an energy receiving device may transmit an energy request to the energy transmitting UE 115, and the energy transmitting UE 115 may be unable to determine which order to perform the procedures, which may result in increased latency and inefficiency at the energy transmitting UE 115 and/or the energy receiving device.

In order to alleviate the power consumption and latency associated with the multiple transmissions (e.g., requests for data transmissions to charge energy receiving devices and uplink or downlink signaling at the energy transmitting device), the described techniques provide for an energy transmitting UE 115 to prioritize a data transmission from the energy transmitting UE 115, signaling to charge an energy receiving device, or both according to one or more prioritization parameters. For example, the energy transmitting UE 115 may receive instructions to perform the data transmission, one or more requests from energy receiving devices to perform the signaling, or both. The energy transmitting UE 115 may select one or more of the multiple transmissions to perform based on an energy threshold and on the one or more prioritization parameters. In some cases, the energy transmitting UE 115 may prioritize charging an energy receiving device over a different energy receiving device based on the prioritization parameters, may prioritize a data transmission over charging an energy receiving device based on the prioritization parameters, may prioritize the charging request and/or the data transmission according to a first-in-first-out (FIFO) manner based on the prioritization parameters, or any combination thereof. The energy transmitting UE 115 may transmit the selected transmissions, such as signaling to the energy receiving device, a data transmission to a network entity 150 or another UE 115, or both.

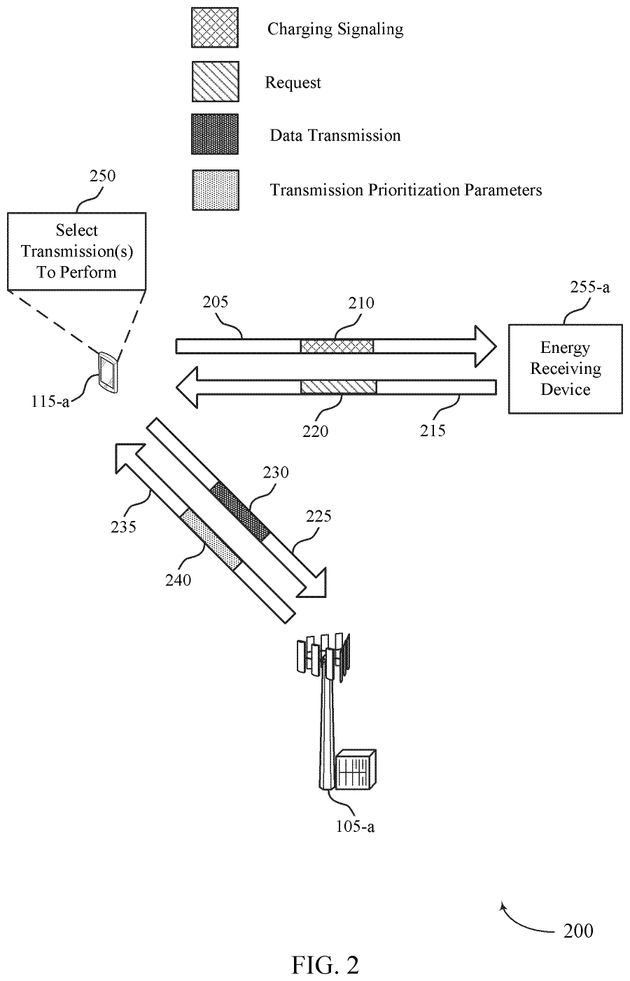

FIG. 2 illustrates an example of a wireless communications system 200 that supports prioritizing an energy request or data transmissions for EH procedures in accordance with one or more aspects of the present disclosure. In some examples, wireless communications system 200 may implement aspects of wireless communications system 100. For example, wireless communications system 200 may support communications between a network entity 105-a and UE 115-a, which may be examples of corresponding network entities 105 and UEs 115 as described with reference to FIG. 1. In some examples, network entity 105-a may communicate with one or more UEs 115 within a geographic coverage area.

The UE 115-a may send transmissions to an energy receiving device 255-a via link 205, and the energy receiving device 255-a may send transmissions to the UE 115-a via link 215. For example, the UE 115-a may be an energy transmitting UE, and may charge the energy receiving device 255-a using RF waves (e.g., charging signaling 210, which may also be referred to as signaling power) via the link 205. The charged energy receiving device 255-a may transmit control signaling, data, or both to the UE 115-a or another wireless device via a link 215. The network entity 105-a may send downlink transmissions (e.g., control signaling, data, or both) to UE 115-a over downlink communication link 235 and the UE 115 a may correspondingly send uplink transmissions (e.g., control signaling, data, or both) to the network entity 105-a over uplink communication link 225.

In some examples, the network entity 105-a may perform the charging signaling 210 in addition to, or instead of, the UE 115-a. Similarly, the network entity 105-a may communicate directly with the energy receiving device 255-a to schedule data transmissions, such that the energy receiving device 255-a may transmit a request 220 for energy in accordance with the scheduled data transmissions. The energy transmitting device, such as the UE 115-a and/or the network entity 105-a, may have an energy budget (e.g., a limited quantity of energy dedicated to transmissions), which may correlate to limited time resources for transmissions, frequency resources for transmissions, or power resources for transmissions. In some cases, the UE 115-a may determine to perform multiple transmissions, such as an uplink transmission to the network entity 105-a and the charging signaling 210 (e.g., energy transmission), and the UE 115-a may be unable to prioritize and select which transmissions to perform. Thus, in some examples, the UE 115-a may prioritize one or more transmissions of the multiple transmissions in order to decrease latency and increase efficiency.

For example, multiple energy receiving devices 255 may transmit requests for energy (e.g., a request 220) to the UE 115-a, and the UE 115-a may have a limited quantity of energy to transmit. Based on a class of the energy receiving device 255-a, the request 220 may have (e.g., may be given) a priority indicator (e.g., a level for charging). The class of energy receiving device 255-a may include an indication of one or more of the minimum or default (e.g., a nominal or average or expected) charging rate, a minimum or default (e.g., average or expected or nominal) discharge rate (e.g., due to operation: being in an ON state: operating in a power saving mode: turning on some hardware components: turning on some RF components: engagement on reception, transmission, processing of information: signal, battery, or energy storage unit leakage due to impairments: or the like), a data rate (e.g., for transmission or reception decoding by the EH device), EH techniques (charging via RF, solar, thermal, vibration, light/laser, etc.), the RF EH architecture (time-switching RF-EH architecture, power splitting RF-EH architecture, separated architecture RF EH, etc.) used, a capability to harvest RF energy from one or more of frequency bands, a capability to harvest from different types of EH technologies (solar, thermal, RF, light or laser, vibration, etc.), or an application monitored by the energy receiving device 255 (an energy receiving UE 255 may be used for medical sensing, medical measurements, thermal sensing, tracking the expiry rate of goods, positioning, etc.). In this example, a relatively low priority indicator value may have a relatively higher priority of the request (e.g., a 1 may indicate a high priority). For example, energy receiving devices 255 with a low charging rate, or a high discharge rate, or any combination thereof, may have higher priority than other energy receiving devices 255. Energy receiving devices 255 with a high data rate or sensitive applications may have a higher priority.

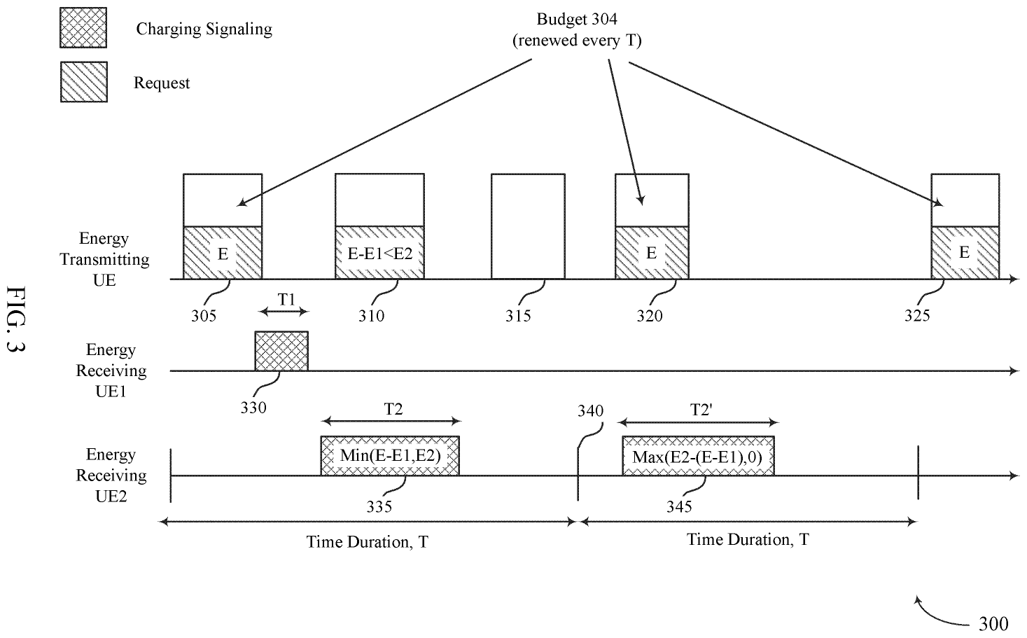

In some examples, however, multiple energy receiving devices 255 may send a request 220 of a same class, which may result in a prioritization conflict at the UE 115-a. In this case, the multiple energy receiving devices 255 may indicate a priority of the requests 220 by including one or more parameters in the requests 220, which may allow for the UE 115-a to resolve the conflict. Each of the logical channel groups (LCGs) of the energy receiving device 255 may have a priority based on a logical channel prioritization (LCP). For example, the UE 115-a may determine an overall priority of the requests 220 by comparing a priority indicator (e.g., highest data priority, highest QoS level, current discharge rate, current charging rate, EH calls, among others) of the requests 220, a minimum remaining PDB of a data packet included in the data (e.g., regardless of which LCG the data packet belongs to) of the requests 220, or both. The highest data priority of the requests 220 may be associated with an L1 priority (e.g., PHY priority), and the priority of the data packet (e.g., the minimum remaining PDB of the data packet) may be associated with an L3 priority (e.g., LCPs or priority of LCGs). The energy receiving device 255-a indicates both of the types of priorities by including a joint parameter (e.g., a parameter that represents the joint priorities of L1 and L3). In some cases, the highest data priority of the requests 220 may be based on an EH class, a current charging rate, a current discharge rate, a QoS level, and the like of the energy receiving devices 255. The UE 115-a may determine the order in which to fulfill the requests 220 (e.g., transmit charging signaling 210) based on the comparison. The UE 115-a may transmit an energy transmission (e.g., charging signaling 210) based on the order, based on whether the requests 220 overlap in the time domain, or based on the energy budget of the UE 115-a, or any combination thereof, which may be described in further detail with reference to FIG. 3.

Additionally, or alternatively, the priority of the requests 220 may be based on a priority of a data transmission to the energy receiving device 255. For example, the UE 115-a may receive information regarding a data reception priority of the energy receiving device 255 (e.g., the information may indicate a data priority of a packet that the energy receiving device 255 may be scheduled to receive from a network entity 105, a UE 115, or both). In this example, the energy receiving device 255 may be aware of the data reception from another device, and the data reception may be associated with a priority. In some examples, a network entity 105 or another UE 115 may transmit the information to the UE 115. In another example, the network entity 105 or the UE 115 may transmit the information to the energy receiving device 255, and the energy receiving device may include the information in the request 220 to the UE 115-a (e.g., as part of the joint parameter).

Additionally, or alternatively, the priority of the requests 220 may be based on a priority of data transmission (e.g., a data transmission performed by the energy receiving device 255). For example, the energy receiving device 255 may be scheduled to perform a data transmission to another device using the energy from the charging signaling 210. The data packets in the data transmission may have a priority, and the energy receiving device may include an indication of a highest priority (e.g., highest priority indices) of the data packets in the request 220. The data packets may have an L1 priority, a L3 priority, or both (e.g., both may be included in the joint parameter). Additionally, or alternatively, the priority of the requests 220 may be based on a minimum remaining PDB of a data packet that may be included in the data reception of the energy receiving device 255, the data transmission of the energy receiving device 255, or both (e.g., the energy receiving device 255 may use the energy from the control signaling 210 to receive and transmit the data packets).

Additionally, or alternatively, an energy receiving device 255-a may transmit a request 220 to the UE 115-a, and may include a parameter to indicate one or more of an energy state of the energy receiving device 255-a, a current QoS condition associated with charging, a current transmit data rate condition, a current receive data rate condition, a UE class, a QoS value (e.g., level) of data to be received, decoded, or transmitted by the energy receiving device 255-a, a highest data priority (e.g., based on comparing the priorities of data packets to be received, decoded, or transmitted by the energy receiving device 255-a) of the request 220 (e.g., L1 priority, L3 priority, or both of transmitted or received data), the minimum remaining PDB of a data packet included in the data (e.g., a buffered data packet) of the request 220, the PDB of a data packet with a highest data priority of the request 220, a current QoS requirement associated with charging, a minimum or default (e.g., current) charging rate of the energy receiving device 255-a, a minimum or default discharge (e.g., discharging) rate of the energy receiving device 255, or a time of arrival of the request 220. In some examples, the term default may refer to an average or expected value. In some examples, the energy receiving device 255-a may transmit (e.g., without the parameter) one or more of an energy state of the energy receiving device 255-a, a current QoS condition associated with charging, a current transmit data rate condition, a current receive data rate condition, a UE class, a highest data priority of the energy receiving device 255-a (e.g., of data to be received, decoded, or transmitted), the minimum remaining PDB of a data packet included in the data (e.g., a buffered data packet), the remaining PDB of a data packet corresponding to the highest data priority, a minimum or default (e.g., current) charging rate of the energy receiving device 255-a, a minimum or default discharge (e.g., discharging) rate of the energy receiving device 255, or a time of arrival of the request 220. For example, multiple energy receiving devices 255 may each transmit a request 220 with a parameter, and the UE 115-a may determine that the request 220 of the energy receiving device 255-a has the highest priority when compared with the other requests or the highest discharge rate when compared with the other energy receiving devices 255 (e.g., a relatively poor energy condition). That is, in the context of the energy state of the energy receiving device 255, if the device has a high discharge rate or poor energy conditions, the energy state may become relatively low faster than other energy receiving devices 255. In some examples, a current condition may refer to an instantaneous or last observed value before sending a report. The UE 115-a may fulfill the request 220 for the UE 115-a by selecting to transmit charging signaling 210, or an energy transmission, to the energy receiving device 255-a prior to transmitting charging signaling 210 to other energy receiving devices 255. That is, the UE 115-a may select an energy transmission to perform to the energy receiving device 255-a at 250, rather than transmitting energy transmissions to other energy receiving devices 255.

In some examples, if the energy receiving device 255-a is aware of a priority of data the energy receiving device 255-a is scheduled to receive (e.g., indicated by the energy transmitting UE 115-a, the network entity 105-a, or another transmitting device), the energy receiving device 255-a may include the priority of data the energy receiving device 255-a is scheduled to receive as a parameter in the request 220. Additionally, or alternatively, the energy receiving device 255-a may transmit the priority of data the energy receiving device 255-a is scheduled to receive as separate information (e.g., in addition to the request 220) to the UE 115-a, the network entity 105-a, or both. In some cases, the UE 115-a, the network entity 105-a, or both may receive the request 220 from another wireless device (e.g., helper device), or the UE 115-a may receive the request 220 from the network entity 105-a. For example, the energy receiving device 255-a may transmit the request 220 to the network entity 105-a, then the network entity 105-a may relay the information from the request 220 to an energy provider (e.g., the UE 115-a). In such examples, the network entity 105-a may forward the request 220 and one or more priorities (e.g., of the request, of the signaling at the energy receiving device 255-a, or any other priority vale) to the energy provider. Additionally, or alternatively, the network entity 105-a may provide additional information, such as the priority of reception data at the energy receiving device 255-a, to the energy provider (e.g., the UE 115-a). The network entity 105-a may have the additional information due to scheduling the reception of data at the energy requesting device 255-a (e.g., the energy receiving device 255-a may receive the data from the network entity 105-a). The additional information may indicate for the UE 115-a to modify or provide additional requests for a priority of the request 220 from the energy receiving device 255-a.

Additionally, or alternatively, in the case that the UE 115-a has limited time, frequency, or power resources, at 250, the UE 115-a may select the order in which to fulfill the requests 220 (e.g., a prioritization schedule) based on the time arrival of the requests 220 in a FIFO manner. For example, the network entity 105-a may transmit control signaling (e.g., RRC signaling) to the UE 115-a, and the control signaling may indicate for the UE 115-a to transmit charging signaling 210 to multiple energy receiving devices 255-a based on the order that the UE 115-a received the requests 220.

In some examples, the UE 115-a may prioritize between transmitting a data transmission 230 to the network entity 105-a or charging signaling 210 to the energy receiving device 255-a. In this example, the UE 115-a may prioritize the data transmission 230 over the charging signaling 210. Additionally, or alternatively, the energy receiving device 255-a may transmit the request 220, and the request 220 may include an indication of a highest priority of data the energy receiving device 255-a may transmit (e.g., a highest data priority that the energy receiving device 255-a may transmit during a time interval) an indication of a highest data priority of buffered data associated with the request 220 (e.g., the buffered data in a transmission queue of the energy receiving device 255-a), or both. The highest data priority of the requests 220 may have with an L1 priority, and the priority of the data packet (e.g., the minimum remaining PDB of the data packet) may have an L3 priority. The energy receiving device 255-a may indicate both of the types of priorities by including a joint parameter (e.g., a parameter that represents the joint priorities of L1 and L3). The UE 115-a may compare the priority of the data transmission 230 with the priority of the request 220 (e.g., the highest data priority that the energy receiving device 255-a reported in the request 220). For example, if the UE 115-a determines that the priority of the data transmission 230 is relatively higher than the priority of the request 220, the UE 115-a may select to transmit the data transmission 230 to the network entity 105-a. In some other examples, if the UE 115-a determines that the priority of the request 220 is relatively higher than the priority of the data transmission 230, the UE 115-a may select to transmit the charging signaling 210 to the energy receiving device 255-a.

Additionally, or alternatively, the priority of the transmissions may be based on a priority of a data transmission to the energy receiving device 255. For example, the UE 115-a may receive information regarding a data reception priority of the energy receiving device 255 (e.g., the information may indicate a data priority of a packet that the energy receiving device 255 may be scheduled to receive from a network entity 105, a UE 115, or both). In this example, the energy receiving device 255 may be aware of the data reception from another device, and the data reception may have a priority. In some examples, a network entity 105 or another UE 115 may transmit the information to the UE 115. In another example, the network entity 105 or the UE 115 may transmit the information to the energy receiving device 255, and the energy receiving device may include the information in the request 220 to the UE 115-a (e.g., as part of the joint parameter).

Additionally, or alternatively, the priority of the transmissions may be based on a priority of data transmission (e.g., a data transmission performed by the energy receiving device 255). For example, the energy receiving device 255 may be scheduled to perform a data transmission to another device using the energy from the charging signaling 210. The data packets in the data transmission may have a priority, and the energy receiving device may include an indication of the highest priority (e.g., highest priority indices) of the data packets in the request 220. The data packets may have an L1 priority, an L3 priority, or both (e.g., both may be included in the joint parameter). Additionally or alternatively, the priority of the requests 220 may be based on a minimum remaining PDB of a data packet that may be included in the data reception of the energy receiving device 255, the data transmission of the energy receiving device 255, or both (e.g., the energy receiving device 255 may use the energy from the control signaling 210 to receive and transmit the data packets).

Additionally, or alternatively, the UE 115-a may select to transmit an energy transmission to the energy receiving device 255-a by transmitting the data transmission 230 (e.g., a repeated or copy version of the data transmission 230) to the energy receiving device 255-a. For example, the UE 115-a may coordinate with a wireless device receiving the data transmission 230 (e.g., the network entity 105-a), such that the wireless device may perform combining with the repetition of the data transmission 230 that the UE 115-a uses to charge the energy receiving device 255-a. Combining the repetition at the wireless device may increase reliability of the transmission, while also providing for the UE 115-a to charge the energy receiving device 255-a with the repetition of the data transmission 230. The repetition of the data transmission 230 may be a portion of the data transmission 230, a layer of the data transmission 230, a portion of OFDM symbols of the data transmission 230, a portion of resource blocks (RBs) of the data transmission 230, or any combination thereof.

Additionally, or alternatively, the network entity 105-a may transmit control signaling, which may configure the UE 115-a with one or more transmission prioritization parameters 240. The transmission prioritization parameters 240 may be transmitted to the UE 115-a via RRC signaling, or the transmission prioritization parameters 240 may be dynamically configured with a medium access control-control element (MAC-CE), downlink control information (DCI), or both. Based on the transmission prioritization parameters 240, the UE 115-a may select to transmit charging signaling 210 or the data transmission 230, which is further described with reference to FIG. 3.

Additionally, or alternatively, the UE 115-a may prioritize between responding to the request 220 or the data transmission 230 based on a parameter included in the request 220 by the energy receiving device 255-a. The parameter may indicate one or more of an energy state of the energy receiving device 255-a, a highest data priority of the request 220, or both. For example, the UE 115-a may be scheduled to perform a data transmission 230 (e.g., the network entity 105-a may schedule the data transmission 230 at the UE 115-a), and the UE 115-a may receive the request 220 to transmit the charging signaling 210 concurrently with the data transmission 230. The UE 115-a may determine which transmission to perform using limited time, frequency, or power resources based on an energy threshold, which may be determined from the energy state included in the request 220. In some examples, if the UE 115-a determines that the energy state of the energy receiving device 255-a is in relatively good condition (e.g., the energy receiving device 255-a satisfies the energy threshold), the UE 115-a may select to perform the data transmission 230, rather than fulfill the request 220 and transmit the charging signaling 210 to charge the energy receiving device 255-a. In some other examples, if the UE 115-a determines that the energy state of the energy receiving device 255-a is in a relatively poor condition (e.g., the energy receiving device 255-a fails to satisfy the energy threshold), the UE 115-a may select to transmit the charging signaling 210 to the energy receiving device 255-a., In some cases, the UE 115-a may adjust the energy threshold in comparing the priority of the request 220 and the data transmission 230. In this case, the UE 115-a may adjust the energy threshold such that if the energy receiving device 255-a has a relatively low energy level, the request 220 may have a higher priority relative to the data transmission 230.

Additionally, or alternatively, based on comparing the priority of the data transmission 230 and the request 220, where the priority of the request 220 is a highest priority of data at the energy receiving device 255-a, the UE 115-a may satisfy higher priority requests 220, then use a remaining energy for sending energy to additional requests 220, such that the energy receiving devices 255 may receive a fraction of what they asked for. For example, the UE 115-a may transmit a portion of energy to the energy receiving device 255-a, where the network entity 105-a may configure the portion, or the portion may be otherwise defined. Additionally, or alternatively, if the data transmission 230 and the request 220 have a same priority, the UE 115-a may be configured to perform the data transmission 230. In some examples, the network entity 105-a may indicate via control signaling (RRC signaling, MAC-CE, DCI, etc.) the transmission to select, which may be dynamically configured (e.g., change) over time. Additionally, or alternatively, the control signaling may indicate for the UE 115-a to prioritize the transmissions based on time of arrival in a FIFO manner. For example, the UE 115-a may use the priority of the transmissions, the time of arrival of the requests 220 and a data transmission request from the network entity 105-a, or both, to select the order in which to perform the transmissions. The UE 115-a may determine a transmission schedule (e.g., prioritization schedule) by determining which request to satisfy first, or which request to satisfy when the UE 115-a has limited resources for the transmissions.

In some examples, the energy receiving devices 255 may wake up to perform wireless communications with other devices. The quantity of wake up time (e.g., the amount of time the energy receiving device 255 may be awake) may have a corresponding energy use (e.g., a relatively long wake up time may have a relatively high amount of energy use). In this case, the UE 115-may prioritize energy receiving devices 255 based on the energy use for the wake up time for the device. For example, the prioritized energy receiving devices 255 may have a class or type related to a power consumption profile of the energy receiving device 255 (e.g., a discharge rate of the energy receiving device 255), a quantity of energy (e.g., energy cost) for the energy receiving device 255 to wake up, a combination of the class and the energy state of the energy receiving device 255, or any combination thereof. The energy receiving devices 255 may indicate the class or type with a parameter included in the request 220 to the UE 115-a. The parameter may indicate the UE type or class, one or more of an energy state of the energy receiving device 255-a, a highest data priority of the request 220, or any combination thereof. The UE 115-a may fulfill the requests 220 in a shorter amount of time for the energy receiving devices 255 with a relatively high energy consumption profile, a relatively high energy cost, and/or a relatively high priority (e.g., the prioritized energy receiving devices 255). The UE 115-a may transmit the charging signaling 210 to the prioritized energy receiving devices 255. Additionally, or alternatively, the network entity 105 may prioritize scheduling downlink grants to transmit to the prioritized energy receiving devices 255.

In some examples, the energy receiving device 255-a may be an example of a modem that is performing an EH function and may rely on EH technology (e.g., backscatter technology for zero power devices). For example, the energy receiving device 255-a may have an NR modem, an LTE modem, an enhanced reduced capacity (eRedCap) (e.g., or few microwatts) modem, or the like. The energy receiving device 255-a may use the EH for power. The energy receiving device 255-a may be in an RFID system (e.g., may be an RFID tag). In some examples, a UE may have multiple radios (e.g., two radios), such as a main radio (e.g., that can use EH, or not) and an RFID tag radio. The UE may use the RFID tag radio at a low power or energy modem, by configuration from the network entity 105-a, or by decision from the UE (e.g., to put one or more components in sleep mode). In some cases, one or more UEs that rely on the EH technology (e.g., RF) may operate in a dedicated low power radio for EH (e.g., as a part or subset of the main radio of the UE).

FIG. 3 illustrates an example of an energy transmission scheme 300 that supports prioritizing an energy request or data transmissions for EH procedures in accordance with one or more aspects of the present disclosure. In some examples, the energy transmission scheme 300 may implement aspects of wireless communications system 100 and wireless communications system 200. For example, the energy transmission scheme 300 may illustrate aspects of techniques performed by one or more energy receiving devices 255 (e.g., an energy receiving UE1 and an energy receiving UE2) and an energy transmitting UE 115, which may be examples of energy receiving devices 255 and UEs 115 as described with reference to FIGS. 1 and 2. For example, the energy transmitting UE may transmit charging signaling 315 (e.g., one or more energy transmissions) to charge an energy receiving UE1 (e.g., UE1), an energy receiving UE2 (e.g., UE2), or both based on an energy budget 304 of the energy transmitting UE 115.

In some examples, the energy transmitting UE may prioritize one or more of the multiple transmissions to decrease latency and increase efficiency. For example, as described with reference to FIG. 2, an energy transmitting UE may receive multiple requests for energy from multiple energy receiving devices, and the energy transmitting UE may prioritize transmitting charging signaling to one or more of the energy receiving devices. For example, the UE1, the UE2, or both may transmit a request to the energy transmitting UE for energy transmissions, or charging signaling. The energy transmitting UE may have a limited amount of energy (e.g., a total energy budget 304) to transmit within a time duration, T, and the amount of energy may be renewed at the start of each time duration, T. In some cases, the energy transmitting UE may not be able to fulfill the one or more requests within the time duration, T. Thus, based on the class of UE1 or UE2, the request for energy at 305 may be given a priority indicator for charging based on one or more parameters included in the request. In this example, the UE1 and the UE2 may both transmit a request to the energy transmitting UE, where UE1 may transmit the request for energy at 305 and UE2 may transmit a request for energy at 310.

In some examples, UE1, UE2, or both may transmit the one or more parameters (e.g., as tables) to other UEs 115 (e.g., the energy transmitting UE) via sidelink. In another example, a network entity 105, a network unit, or the like may transmit the one or more parameters to multiple UEs 115 (e.g., a set or a group of UEs 115) via an initial access messages, such as a master information block (MIB), a cell-specific system information block (e.g., SIB1), a non-master system information block (OSIB), or dedicated signaling. The energy transmitting UE may receive a parameter of UE1 (e.g., P1) in the request at 305 (e.g., R1) for charging signaling during a time T1 and a parameter of UE2 (e.g., P2) in the request at 310 (e.g., R2) from UE2 for charging signaling during a time T2.

The energy transmitting UE may compare the highest data priority of UE1 included in the request at 305 and the highest data priority of the UE2 included in the request at 310, and based on the comparison, the energy transmitting UE may transmit the charging signaling to the UE with the highest data priority. The energy transmitting UE may be associated with a total energy budget 304 of E every T seconds (e.g., the time duration T), where the energy transmitting UE may transmit the charging signaling to UE1, UE2, or both according to their respective one or more parameters (e.g., the energy transmitting UE can transmit charging signaling, such that (P1×T1)+(P2×T2)≤E, where T1+T2≤T). The energy transmitting UE may determine which request (e.g., the request at 305 or the request at 310) may be fulfilled first, whether the requests may both be fulfilled in the duration of time, T (e.g., if the requests overlap in time), or if the energy transmitting UE may be unable to fulfill both of the requests within the time, T. Based on the determination, the energy transmitting UE may transmit charging signaling to UE1, UE2, or both within the time T. In some examples, the energy transmitting UE may not have enough total energy budget 304 to perform both charging signaling transmissions, and the energy transmitting UE may transmit portions of the energy requested by UE1, UE2, or both at different time durations during T, until the energy request is satisfied (e.g., the energy transmitting UE may assign part or the entirety of the remaining total energy budget to a lower priority UE).

Additionally, or alternatively, as described with reference to FIG. 2, the energy transmitting UE may receive a request for energy from an energy receiving device (e.g., UE1, UE2, or both), a request for data transmission from a network entity, or both. The energy transmitting UE may prioritize the transmissions based on the one or more parameters, the control signaling, or both. In some examples, the energy transmitting UE may be RRC configured or indicated dynamically (MAC-CE or DCI) by the network entity with transmission prioritization parameters (e.g., expected behavior for a transmission conflict at the energy transmitting UE) via control signaling. For example, the network entity may transmit control signaling indicating for the energy transmitting UE to select which transmission to perform based on a transmission prioritization parameter. For example, the energy transmitting UE may select a transmission based on a first parameter (e.g., P1), and the energy transmitting UE may select another transmission based on a second parameter (e.g., P2), where the parameter may change over time (e.g., the energy transmitting UE may switch between parameters based on the control signaling indication). In some examples, the network entity may transmit a sequence or a pattern of the parameters over time for the energy transmitting UE to select transmissions. For example, the energy transmitting UE may not be scheduled to perform a data transmission, and the energy transmitting UE may receive a request for an energy and determine to fulfill the request. In some other examples, based on the priority of the transmissions, the energy transmitting UE may transmit the data transmission by using a quantity of energy, and the energy transmitting UE may use the remaining energy in the energy budget 304 to transmit charging signaling to the energy receiving device.

Additionally, or alternatively, a network entity may transmit control signaling to the energy transmitting UE, which may configure the energy transmitting UE to fulfill the requests based on a time of arrival in a FIFO manner. For example, the UE1 may transmit a request at 305 at an earlier time than UE2 may transmit a request at 310. Based on the time of arrival of the requests, the energy transmitting UE may fulfill the entirety of the request at 305 by transmitting charging signaling 330 (e.g., E1) to UE1. The energy transmitting UE may then transmit the difference, or a portion of the difference (e.g., E2) between the total energy budget 304, E, and charging signaling 330 (e.g., E2<E-E1) as charging signaling 335 over a period of time, T2. In some examples, the charging signaling 335 may be the entirety of the request at 310 (e.g., the entirety of energy that the UE2 requests). In some other examples, the charging signaling 335 may be a minimum of the difference between the total energy budget 304, E, and charging signaling 330 (e.g., E-E1) or E2, such that the charging signaling 335 may be a portion of the request 310 (e.g., a portion of the energy that the UE2 requests). In this example, the energy transmitting UE may fulfill the request at 310 in another (e.g., a next) time duration T after time 340. The energy transmitting UE may have a total energy budget 304, E, such that at 315 the energy budget is used, and the energy transmitting UE cannot transmit additional signaling. Once the budget 304 is renewed, the energy transmitting UE may entirely fulfill another request at 320 with a portion of the energy budget 304 by transmitting charging signaling 345.

In some examples, such as when the charging signaling 335 may be the entirety of the budget 304 based on the request at 320, any additional charging signaling during the time duration, T, may have an energy value of zero. In some other examples, the charging signaling 335 may be a maximum of the difference between E2 and the difference between the total energy budget 304, E, and charging signaling 330 (e.g., Max (E2-(E-E1))) and zero. The energy transmitting UE may receive another request at 320 or another request at 325 during the next time duration T, and the energy transmitting UE may determine to fulfill the request at 320 or at 325 based on a priority of the UE2, a time of arrival prioritization, or both.

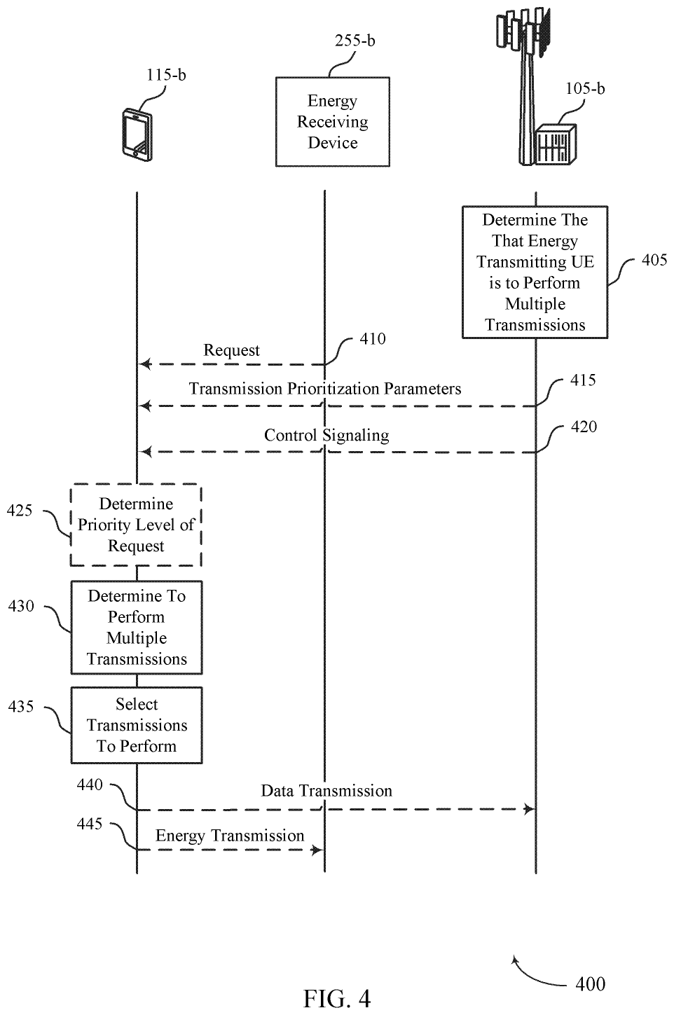

FIG. 4 illustrates an example of a process flow 400 that supports prioritizing an energy request or data transmissions for EH procedures in accordance with one or more aspects of the present disclosure. In some examples, process flow 400 may implement aspects of wireless communications systems 100, wireless communications system 200, and energy transmission scheme 300. The process flow 400 may illustrate an example of a UE 115-b (e.g., an energy transmitting UE) determining whether to prioritize an energy transmission to an energy receiving device 255-b or a data transmission to or from another device, such as the network entity 105-b, which may be examples of a network entity 105, a UE 115, and an energy receiving device 255 as described with reference to FIGS. 1 through 3. Alternative examples of the following may be implemented, where some processes are performed in a different order than described or are not performed. In some cases, processes may include additional features not mentioned below, or further processes may be added.

At 405, a network entity 105-b, an energy transmitting UE 115-b, or both may determine that the energy transmitting UE 115-b is to perform multiple transmissions. The multiple transmissions may include a data transmission to a wireless device, one or more energy transmissions (e.g., charging signal) to charge energy receiving devices (e.g., the energy receiving device 255-b) in response to one or more requests from the energy receiving devices, or both.

At 410, in some examples, the energy receiving device 255-b may transmit a request to the energy transmitting UE 115-b to charge the energy receiving device 255-b. In some other examples, the energy receiving device 255-b may transmit a request to the network entity 105-b to charge the energy receiving device 255-b. In some cases, the request may indicate the one or more parameters of the energy receiving device 255-b, such as an energy state of the energy receiving device 255-b, a QoS value (e.g., level) of the data packet to be received and/or decoded at the energy receiving device 255-b, a QoS value (e.g., level) of the data packet to be transmitted by the energy receiving device 255-b, a priority of data at the energy receiving device 255-b, priority of data to be received and/or decoded by the energy receiving device 255-b, a current QoS condition associated with charging, a current transmit data rate condition, a current receive data rate condition, a remaining PDB of highest priority data packet to be received or transmitted by the energy receiving device 255-b, or the like.

In some examples, the energy receiving device 255-b may indicate a remaining PDB of a highest priority data or highest priority of a packet (e.g., an L1 priority, an L3 priority, or a combination of L1 and L3 priorities) for the packets that are stored, or buffered, for transmission at the energy receiving device 255-b. For example, the energy receiving device 255-b may transmit a parameter (e.g., in the energy request) that indicates an L1 priority (e.g., PHY priority), an L3 priority (e.g., LCP or priority of LCGs), or both. The priority may be based on a receive data priority of a packet that the energy receiving device 255-b receives (e.g., a reception priority if the energy receiving device 255-b is receiving data from another device). In some examples, the transmitting device may indicate the receive data priority to the energy receiving device 255-b. In some cases, the energy receiving device 255-b or transmitting device (e.g., a network entity 105-b) may signal the priority information to the energy transmitting UE 115-b. If the energy receiving device 255-b uses the power, or energy, from the energy transmitting UE 115-b to send a packet and receive a packet (e.g., or multiple packets), then the energy receiving device 255-b may indicate a maximum priority index (e.g., L1 and L3 priorities or a parameter that represent the joint priority). The energy receiving device 255-b may have an additional priority based on a remaining PDB of a packet to be received or transmitted by the energy receiving device 255-b (e.g., if the energy receiving device 255-b uses the power for both).

At 415, in some examples, the network entity 105-b may transmit one or more parameters to the energy transmitting UE 115-b for prioritizing the multiple transmissions (e.g., transmission prioritization parameters) at the energy transmitting UE 115-b. The one or more parameters may include one or more of a QoS value (e.g., level) of the data packet to be received and/or decoded at the energy receiving device 255-b, a QoS value (e.g., level) of the data packet to be transmitted by the energy receiving device 255-b, a priority of data at the energy receiving device 255-b, priority of data to be received and/or decoded by the energy receiving device 255-b, a remaining PDB of the data packets to be received or transmitted by the energy receiving device 255-b, a QoS condition (e.g., requirement) associated with charging, a current Qos condition associated with charging, a current transmit data rate condition, a current receive data rate condition, a UE class, an energy state of the energy receiving device 255-b, a time of arrival of the request. The UE class may indicate one or more of a minimum or default charging rate of the energy receiving device, a minimum or default discharge rate of the energy receiving device, a data rate of the energy receiving device, a charging technique of the energy receiving device, a harvesting architecture of the energy receiving device, a capability to harvest RF energy from one or more of frequency bands, a capability to harvest from different type of EH technologies, or an application monitored by the energy receiving device.

At 420, in some examples, the network entity 105-b may transmit control signaling to the energy transmitting UE 115-b for the energy transmitting UE 115-b to prioritize the multiple transmission according to a first time of arrival of the request, where the one or more parameters may include the time of arrival of the request. In some examples, the control signaling may indicate for the energy transmitting UE 115-b to prioritize the data transmission, the energy transmission to charge the energy receiving device 255-b, or both, according to a prioritization schedule in a time-domain, wherein the one or more parameters comprise the prioritization schedule in the time-domain. In some examples, the control signaling may indicate the one or more parameters, an energy threshold, or both.

At 425, in some examples, the energy transmitting UE 115-b may determine a priority level of the request based on the one or more parameters of the energy receiving device 255-b.

At 430, the energy transmitting UE 115-b may determine to perform multiple transmissions, where each transmission may include a data transmission, an energy transmission to charge the energy receiving device 255-b in response to the request from the energy receiving device 255-b, or both. In some examples, the energy transmitting UE 115-b may determine that transmitting the data transmission or the signaling (e.g., energy transmission) to charge the energy receiving device 255-b uses a first energy value less than the energy threshold.

At 435, the energy transmitting UE 115-b may select one or more transmissions to perform based on the energy threshold and the one or more parameters for prioritizing the multiple transmissions. In some examples, the energy transmitting UE 115-b may select the energy transmission to charge the energy receiving device 255-b based on the priority level of the request satisfying a priority level threshold. In some examples, the energy transmitting UE 115-b may select the energy transmission to charge the energy receiving device 25-b based on the time of arrival of the request being before another time of arrival of a second request from a second energy receiving device 255. In some examples, the energy transmitting UE 115-b may select the energy transmission to charge the energy receiving device 255-b, the data transmission, or both based on the time of arrival of the request satisfying a threshold time of arrival, or the energy transmitting UE 115-b may select the data transmission based on the time of arrival of the request failing to satisfy a threshold time of arrival.

In some examples, the energy transmitting UE 115-b may receive an indication from the energy receiving device 255-b of a first priority of data at the energy receiving device 255-b, and the energy transmitting UE 115-b may select the one or more transmissions based on comparing the first priority of the data at the energy receiving device 255-b and a second priority of the data transmission. In this example, the energy transmitting UE 115-b may select the energy transmission to charge the energy receiving device 255-b based on the first priority being greater than the second priority according to the comparing, or the energy transmitting UE 115-b may select the data transmission based on the second priority being greater than the first priority according to the comparing.

In some examples, the energy transmitting UE 115-b may select the data transmission to perform based on the control signaling from the network entity 105-b. In some examples, the energy transmitting UE 115-b may select the one or more transmissions to perform at an instance in the time-domain based on the prioritization schedule.

At 440 and 445, the energy transmitting UE 115-b may transmit the data transmission or the energy transmission to charge the energy receiving device 255-b based on selecting the data transmission or the energy transmission. In some examples, the energy transmission may include a repetition of the data transmission, such that a receiving device (e.g., a device receiving the data transmission) may combine the repetition, while the repetition concurrently charges the energy receiving device 255-b. In some examples, the energy transmitting UE 115-b may transmit additional energy transmissions to charge an additional energy receiving device 255 based on the energy value being less than the energy threshold. The additional energy transmission may have a second energy value that is a difference between the first energy value and the energy threshold, as described with reference to FIG. 3.

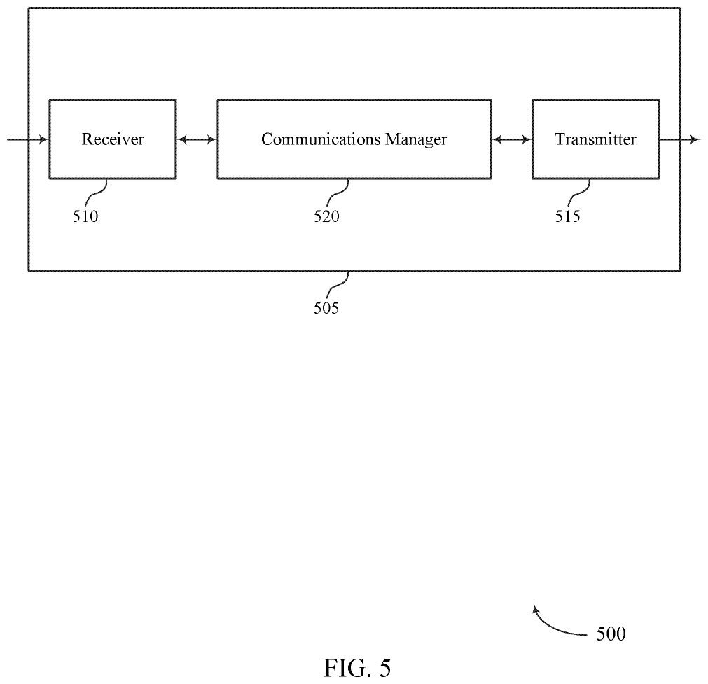

FIG. 5 shows a block diagram 500 of a device 505 that supports prioritizing an energy request or data transmissions for EH procedures in accordance with one or more aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to prioritizing an energy request or data transmissions for EH procedures). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to prioritizing an energy request or data transmissions for EH procedures). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of prioritizing an energy request or data transmissions for EH procedures as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communication at an energy transmitting UE in accordance with examples as disclosed herein. For example, the communications manager 520 may be configured as or otherwise support a means for determining that the energy transmitting UE is to perform a set of multiple transmissions, each transmission of the set of multiple transmissions including a data transmission, an energy transmission to charge an energy receiving device in response to a request from the energy receiving device, or both. The communications manager 520 may be configured as or otherwise support a means for selecting, based on an energy threshold and one or more parameters for prioritizing the set of multiple transmissions, one or more transmissions of the set of multiple transmissions to perform. The communications manager 520 may be configured as or otherwise support a means for transmitting the data transmission, the energy transmission to charge the energy receiving device, or both corresponding to the selection.

By including or configuring the communications manager 520 in accordance with examples as described herein, the device 505 (e.g., a processor controlling or otherwise coupled with the receiver 510, the transmitter 515, the communications manager 520, or a combination thereof) may support techniques for reduced power consumption and more efficient utilization of communication resources.

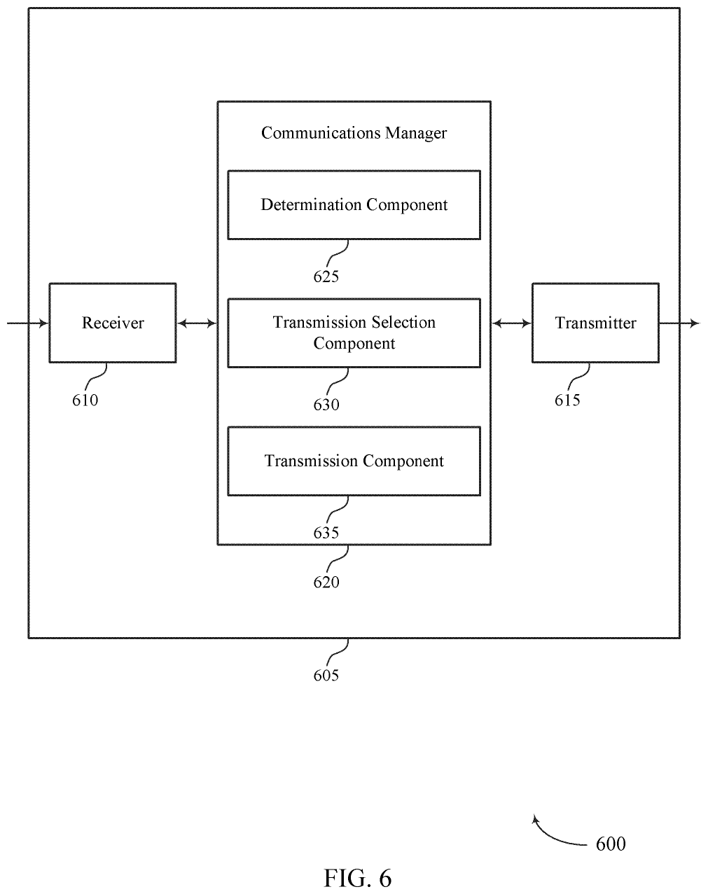

FIG. 6 shows a block diagram 600 of a device 605 that supports prioritizing an energy request or data transmissions for EH procedures in accordance with one or more aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to prioritizing an energy request or data transmissions for EH procedures). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to prioritizing an energy request or data transmissions for EH procedures). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of prioritizing an energy request or data transmissions for EH procedures as described herein. For example, the communications manager 620 may include a determination component 625, a transmission selection component 630, a transmission component 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at an energy transmitting UE in accordance with examples as disclosed herein. The determination component 625 may be configured as or otherwise support a means for determining that the energy transmitting UE is to perform a set of multiple transmissions, each transmission of the set of multiple transmissions including a data transmission, an energy transmission to charge an energy receiving device in response to a request from the energy receiving device, or both. The transmission selection component 630 may be configured as or otherwise support a means for selecting, based on an energy threshold and one or more parameters for prioritizing the set of multiple transmissions, one or more transmissions of the set of multiple transmissions to perform. The transmission component 635 may be configured as or otherwise support a means for transmitting the data transmission, the energy transmission to charge the energy receiving device, or both corresponding to the selection.

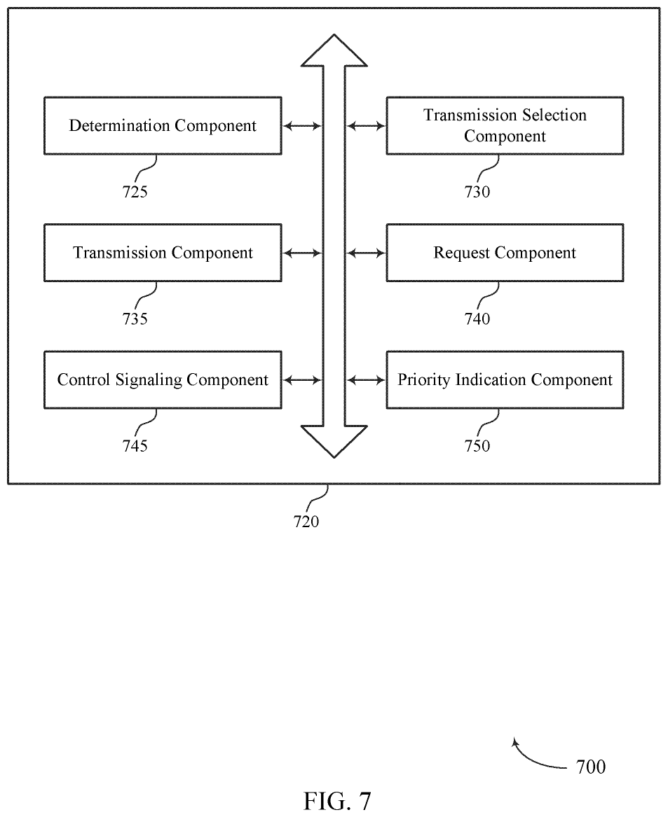

FIG. 7 shows a block diagram 700 of a communications manager 720 that supports prioritizing an energy request or data transmissions for EH procedures in accordance with one or more aspects of the present disclosure. The communications manager 720 may be an example of aspects of a communications manager 520, a communications manager 620, or both, as described herein. The communications manager 720, or various components thereof, may be an example of means for performing various aspects of prioritizing an energy request or data transmissions for EH procedures as described herein. For example, the communications manager 720 may include a determination component 725, a transmission selection component 730, a transmission component 735, a request component 740, a control signaling component 745, a priority indication component 750, or any combination thereof. Each of these components may communicate, directly or indirectly, with one another (e.g., via one or more buses).

The communications manager 720 may support wireless communication at an energy transmitting UE in accordance with examples as disclosed herein. The determination component 725 may be configured as or otherwise support a means for determining that the energy transmitting UE is to perform a set of multiple transmissions, each transmission of the set of multiple transmissions including a data transmission, an energy transmission to charge an energy receiving device in response to a request from the energy receiving device, or both. The transmission selection component 730 may be configured as or otherwise support a means for selecting, based on an energy threshold and one or more parameters for prioritizing the set of multiple transmissions, one or more transmissions of the set of multiple transmissions to perform. The transmission component 735 may be configured as or otherwise support a means for transmitting the data transmission, the energy transmission to charge the energy receiving device, or both corresponding to the selection.

In some examples, to support selecting the one or more transmissions, the request component 740 may be configured as or otherwise support a means for receiving the request from the energy receiving device, the request indicating the one or more parameters of the energy receiving device. In some examples, to support selecting the one or more transmissions, the determination component 725 may be configured as or otherwise support a means for determining a priority level of the request based on the one or more parameters of the energy receiving device. In some examples, to support selecting the one or more transmissions, the transmission selection component 730 may be configured as or otherwise support a means for selecting the energy transmission to charge the energy receiving device based on the priority level of the request satisfying a priority level threshold.

In some examples, the control signaling component 745 may be configured as or otherwise support a means for receiving control signaling indicating for the energy transmitting UE to prioritize the set of multiple transmissions according to a first time of arrival of the request, where the one or more parameters include the time of arrival of the request.

In some examples, to support selecting the one or more transmissions, the transmission selection component 730 may be configured as or otherwise support a means for selecting the energy transmission to charge the energy receiving device based on the time of arrival of the request being before another time of arrival of a second request from a second energy receiving device.

In some examples, to support selecting the one or more transmissions, the transmission selection component 730 may be configured as or otherwise support a means for selecting the energy transmission to charge the energy receiving device, the data transmission, or both based on the time of arrival of the request satisfying a threshold time of arrival. In some examples, to support selecting the one or more transmissions, the transmission selection component 730 may be configured as or otherwise support a means for selecting the data transmission based on the time of arrival of the request failing to satisfy a threshold time of arrival.

In some examples, to support selecting the one or more transmissions, the priority indication component 750 may be configured as or otherwise support a means for receiving an indication of a first priority of data at the energy receiving device. In some examples, to support selecting the one or more transmissions, the transmission selection component 730 may be configured as or otherwise support a means for selecting the one or more transmissions based on comparing the first priority of the data at the energy receiving device and a second priority of the data transmission, where the selecting includes. In some examples, to support selecting the one or more transmissions, the transmission selection component 730 may be configured as or otherwise support a means for selecting the energy transmission to charge the energy receiving device based on the first priority being greater than the second priority in accordance with the comparing. In some examples, to support selecting the one or more transmissions, the transmission selection component 730 may be configured as or otherwise support a means for selecting the data transmission based on the second priority being greater than the first priority in accordance with the comparing.

In some examples, to support selecting the one or more transmissions, the control signaling component 745 may be configured as or otherwise support a means for receiving control signaling indicating for the energy transmitting UE to prioritize the data transmission, where the control signaling includes the one or more parameters. In some examples, to support selecting the one or more transmissions, the transmission selection component 730 may be configured as or otherwise support a means for selecting the data transmission to perform based on the control signaling.

In some examples, to support selecting the one or more transmissions, the control signaling component 745 may be configured as or otherwise support a means for receiving control signaling indicating for the energy transmitting UE to prioritize the data transmission, the energy transmission to charge the energy receiving device, or both, according to a prioritization schedule in a time-domain, wherein the one or more parameters comprise the prioritization schedule in the time-domain. In some examples, to support selecting the one or more transmissions, the transmission selection component 730 may be configured as or otherwise support a means for selecting, at an instance in the time-domain, the one or more transmissions of the set of multiple transmissions to perform based on the prioritization schedule.

In some examples, the control signaling component 745 may be configured as or otherwise support a means for receiving, from a network entity, control signaling indicating the one or more parameters, the energy threshold, or both.

In some examples, the determination component 725 may be configured as or otherwise support a means for determining that transmitting the data transmission or the energy transmission to charge the energy receiving device corresponds to a first energy value less than the energy threshold. In some examples, the transmission component 735 may be configured as or otherwise support a means for transmitting additional energy transmission to charge an additional energy receiving device based on the energy value being less than the energy threshold, the additional signaling corresponding to a second energy value including a difference between the first energy value and the energy threshold.

In some examples, the one or more parameters include a QoS value (e.g., level) of data to be received and/or decoded at the energy receiving device 255-b, a Qos value (e.g., level) of data to be transmitted by the energy receiving device 255-b, a current QoS condition (e.g., requirement) associated with charging, a current transmit data rate condition, a current receive data rate condition, a priority of data at the energy receiving device, priority of data to be received and/or decoded by the energy receiving device, a remaining PDB of data to be received and/or decoded or transmitted by the energy receiving device, a UE class, an energy state of the energy receiving device, a time of arrival of the request, or any combination thereof.

In some examples, the UE class indicates a minimum or default charging rate of the energy receiving device, a minimum or default discharge rate of the energy receiving device, a transmit data rate of the energy receiving device, a receive data rate of the energy receiving device, a QoS associated with charging, a charging technique of the energy receiving device, a harvesting architecture of the energy receiving device, a capability to harvest RF energy from one or more of frequency bands, a capability to harvest from different type of EH technologies, an application monitored by the energy receiving device, or any combination thereof.

In some examples, the energy transmission includes a repetition of the data transmission.

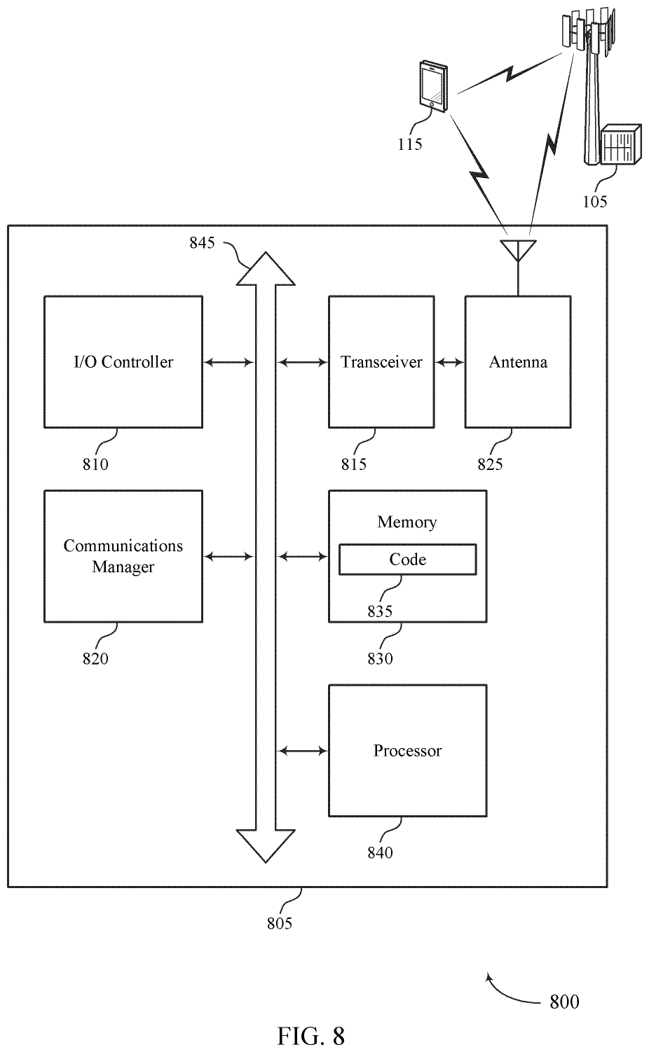

FIG. 8 shows a diagram of a system 800 including a device 805 that supports prioritizing an energy request or data transmissions for EH procedures in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting prioritizing an energy request or data transmissions for EH procedures). For example, the device 805 or a component of the device 805 may include a processor 840 and memory 830 coupled with or to the processor 840, the processor 840 and memory 830 configured to perform various functions described herein.

The communications manager 820 may support wireless communication at an energy transmitting UE in accordance with examples as disclosed herein. For example, the communications manager 820 may be configured as or otherwise support a means for determining that the energy transmitting UE is to perform a set of multiple transmissions, each transmission of the set of multiple transmissions including a data transmission, an energy transmission to charge an energy receiving device in response to a request from the energy receiving device, or both. The communications manager 820 may be configured as or otherwise support a means for selecting, based on an energy threshold and one or more parameters for prioritizing the set of multiple transmissions, one or more transmissions of the set of multiple transmissions to perform. The communications manager 820 may be configured as or otherwise support a means for transmitting the data transmission, the energy transmission to charge the energy receiving device, or both corresponding to the selection.

By including or configuring the communications manager 820 in accordance with examples as described herein, the device 805 may support techniques for improved communication reliability, reduced latency, reduced power consumption, and more efficient utilization of communication resources.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of prioritizing an energy request or data transmissions for EH procedures as described herein, or the processor 840 and the memory 830 may be otherwise configured to perform or support such operations.

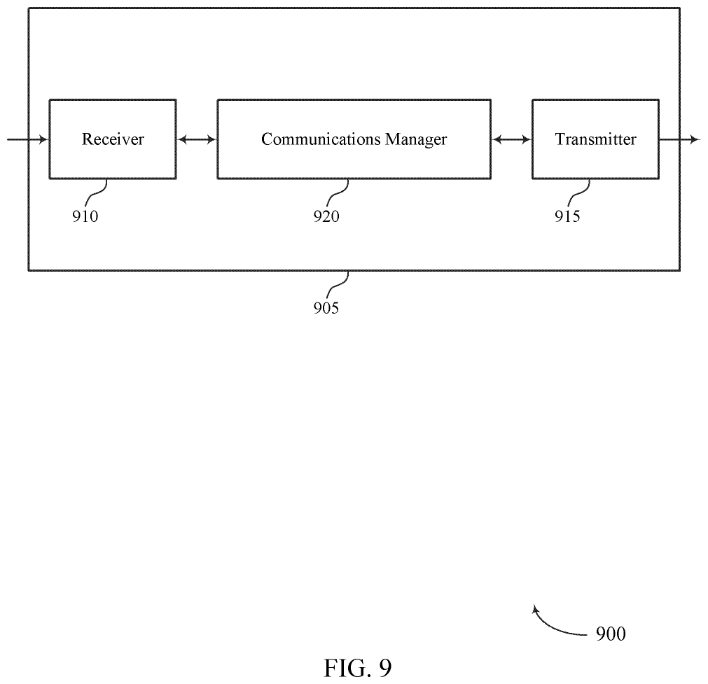

FIG. 9 shows a block diagram 900 of a device 905 that supports prioritizing an energy request or data transmissions for EH procedures in accordance with one or more aspects of the present disclosure. The device 905 may be an example of aspects of a network entity 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations thereof or various components thereof may be examples of means for performing various aspects of prioritizing an energy request or data transmissions for EH procedures as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication at a network entity in accordance with examples as disclosed herein. For example, the communications manager 920 may be configured as or otherwise support a means for determining that an energy transmitting UE is to perform a set of multiple transmissions, each transmission of the set of multiple transmissions including a data transmission, an energy transmission to charge an energy receiving device in response to a request from the energy receiving device, or both. The communications manager 920 may be configured as or otherwise support a means for transmitting, to the energy transmitting UE and based on an energy threshold of the energy transmitting UE, one or more parameters for prioritizing the set of multiple transmissions at the energy transmitting UE.

By including or configuring the communications manager 920 in accordance with examples as described herein, the device 905 (e.g., a processor controlling or otherwise coupled with the receiver 910, the transmitter 915, the communications manager 920, or a combination thereof) may support techniques for reduced power consumption and more efficient utilization of communication resources.

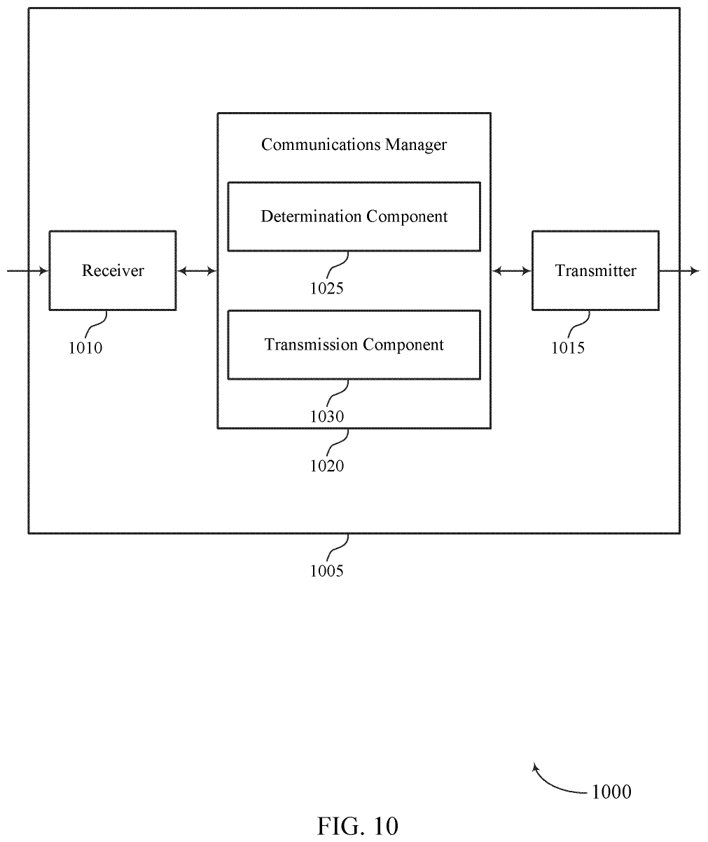

FIG. 10 shows a block diagram 1000 of a device 1005 that supports prioritizing an energy request or data transmissions for EH procedures in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of prioritizing an energy request or data transmissions for EH procedures as described herein. For example, the communications manager 1020 may include a determination component 1025 a transmission component 1030, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication at a network entity in accordance with examples as disclosed herein. The determination component 1025 may be configured as or otherwise support a means for determining that an energy transmitting UE is to perform a set of multiple transmissions, each transmission of the set of multiple transmissions including a data transmission, an energy transmission to charge an energy receiving device in response to a request from the energy receiving device, or both. The transmission component 1030 may be configured as or otherwise support a means for transmitting, to the energy transmitting UE and based on an energy threshold of the energy transmitting UE, one or more parameters for prioritizing the set of multiple transmissions at the energy transmitting UE.

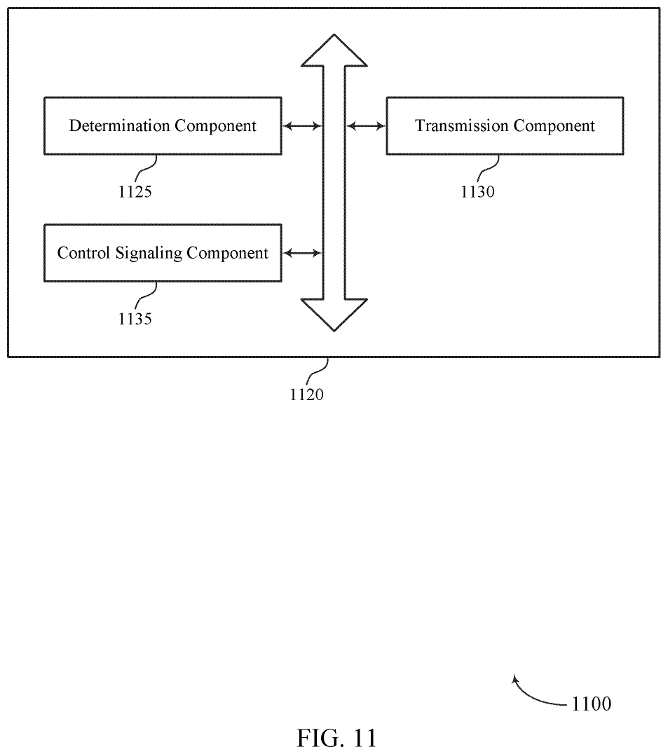

FIG. 11 shows a block diagram 1100 of a communications manager 1120 that supports prioritizing an energy request or data transmissions for EH procedures in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of prioritizing an energy request or data transmissions for EH procedures as described herein. For example, the communications manager 1120 may include a determination component 1125, a transmission component 1130, a control signaling component 1135, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communication at a network entity in accordance with examples as disclosed herein. The determination component 1125 may be configured as or otherwise support a means for determining that an energy transmitting UE is to perform a set of multiple transmissions, each transmission of the set of multiple transmissions including a data transmission, an energy transmission to charge an energy receiving device in response to a request from the energy receiving device, or both. The transmission component 1130 may be configured as or otherwise support a means for transmitting, to the energy transmitting UE and based on an energy threshold of the energy transmitting UE, one or more parameters for prioritizing the set of multiple transmissions at the energy transmitting UE.

In some examples, the control signaling component 1135 may be configured as or otherwise support a means for transmitting control signaling indicating for the energy transmitting UE to prioritize the set of multiple transmissions according to a first time of arrival of the request, where the one or more parameters include the time of arrival of the request.

In some examples, the transmission component 1130 may be configured as or otherwise support a means for transmitting control signaling indicating for the energy transmitting UE to prioritize the data transmission, where the control signaling includes the one or more parameters.

In some examples, the transmission component 1130 may be configured as or otherwise support a means for transmitting control signaling indicating for the energy transmitting UE to prioritize the data transmission, the energy transmission to charge the energy receiving device, or both, according to a prioritization schedule in a time-domain, wherein the one or more parameters comprise the prioritization schedule in the time-domain.

In some examples, the transmission component 1130 may be configured as or otherwise support a means for transmitting, to the energy transmitting UE, control signaling indicating the one or more parameters, the energy threshold, or both.

In some examples, the one or more parameters include a QoS value (e.g., level) the packet to be received and/or decoded at the energy receiving device, a Qos value (e.g., level) of the packet to be transmitted by the energy receiving device, a priority of data at the energy receiving device, priority of data to be received and/or decoded by the energy receiving device, a remaining PDB of the highest priority data to be received and/or decoded or transmitted by the energy receiving device, a UE class, an energy state of the energy receiving device, a time of arrival of the request, or any combination thereof.

In some examples, the UE class indicates a minimum or default charging rate of the energy receiving device, a minimum or default discharge rate of the energy receiving device, a data rate of the energy receiving device, a charging technique of the energy receiving device, a harvesting architecture of the energy receiving device, a capability to harvest RF energy from one or more of frequency bands, a capability to harvest from different type of EH technologies, an application monitored by the energy receiving device, or any combination thereof.

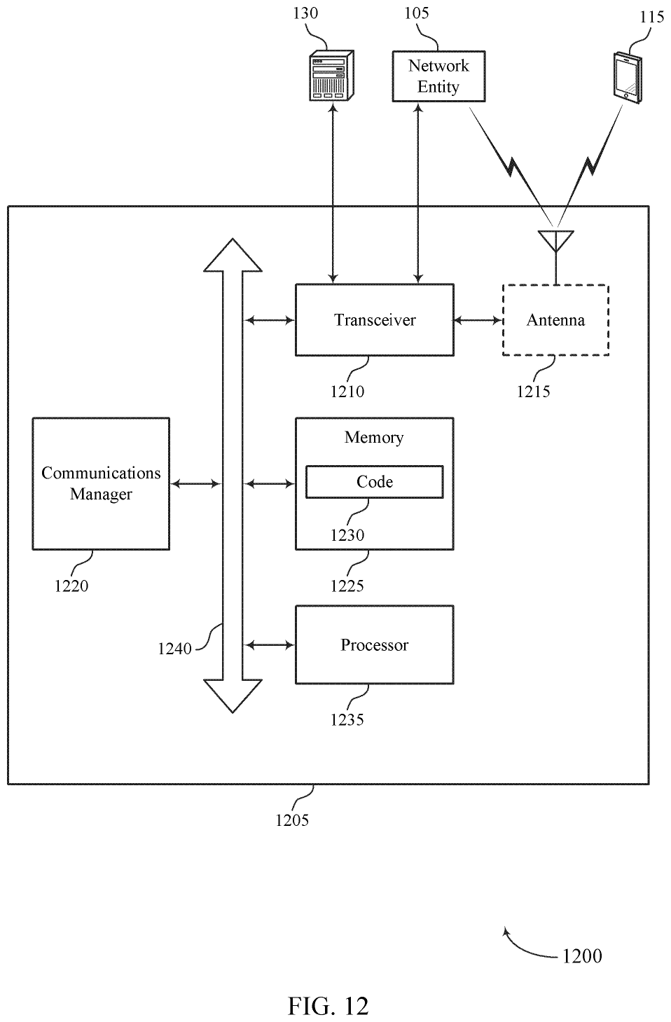

FIG. 12 shows a diagram of a system 1200 including a device 1205 that supports prioritizing an energy request or data transmissions for EH procedures in accordance with one or more aspects of the present disclosure. The device 1205 may be an example of or include the components of a device 905, a device 1005, or a network entity 105 as described herein. The device 1205 may communicate with one or more network entities 105, one or more UEs 115, or any combination thereof, which may include communications over one or more wired interfaces, over one or more wireless interfaces, or any combination thereof. The device 1205 may include components that support outputting and obtaining communications, such as a communications manager 1220, a transceiver 1210, an antenna 1215, a memory 1225, code 1230, and a processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or memory components (for example, the processor 1235, or the memory 1225, or both), may be included in a chip or chip assembly that is installed in the device 1205. In some examples, the transceiver may be operable to support communications via one or more communications links (e.g., a communication link 125, a backhaul communication link 120, a midhaul communication link 162, a fronthaul communication link 168).

The memory 1225 may include RAM and ROM. The memory 1225 may store computer-readable, computer-executable code 1230 including instructions that, when executed by the processor 1235, cause the device 1205 to perform various functions described herein. The code 1230 may be stored in a non-transitory computer-readable medium such as system memory or another type of memory. In some cases, the code 1230 may not be directly executable by the processor 1235 but may cause a computer (e.g., when compiled and executed) to perform functions described herein. In some cases, the memory 1225 may contain, among other things, a BIOS which may control basic hardware or software operation such as the interaction with peripheral components or devices.

The processor 1235 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1235 may be configured to operate a memory array using a memory controller. In some other cases, a memory controller may be integrated into the processor 1235. The processor 1235 may be configured to execute computer-readable instructions stored in a memory (e.g., the memory 1225) to cause the device 1205 to perform various functions (e.g., functions or tasks supporting prioritizing an energy request or data transmissions for EH procedures). For example, the device 1205 or a component of the device 1205 may include a processor 1235 and memory 1225 coupled with the processor 1235, the processor 1235 and memory 1225 configured to perform various functions described herein. The processor 1235 may be an example of a cloud-computing platform (e.g., one or more physical nodes and supporting software such as operating systems, virtual machines, or container instances) that may host the functions (e.g., by executing code 1230) to perform the functions of the device 1205. The processor 1235 may be any one or more suitable processors capable of executing scripts or instructions of one or more software programs stored in the device 1205 (such as within the memory 1225). In some implementations, the processor 1235 may be a component of a processing system. A processing system may generally refer to a system or series of machines or components that receives inputs and processes the inputs to produce a set of outputs (which may be passed to other systems or components of, for example, the device 1205). For example, a processing system of the device 1205 may refer to a system including the various other components or subcomponents of the device 1205, such as the processor 1235, or the transceiver 1210, or the communications manager 1220, or other components or combinations of components of the device 1205. The processing system of the device 1205 may interface with other components of the device 1205, and may process information received from other components (such as inputs or signals) or output information to other components. For example, a chip or modem of the device 1205 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1205 may transmit information output from the chip or modem. Additionally, or alternatively, in some implementations, the one or more interfaces may refer to an interface between the processing system of the chip or modem and a receiver, such that the device 1205 may obtain information or signal inputs, and the information may be passed to the processing system. A person having ordinary skill in the art will readily recognize that a first interface also may obtain information or signal inputs, and a second interface also may output information or signal outputs.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the memory 1225, the code 1230, and the processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with other network entities 105, and may include a controller or scheduler for controlling communications with UEs 115 in cooperation with other network entities 105. In some examples, the communications manager 1220 may support an X2 interface within an LTE/LTE-A wireless communications network technology to provide communication between network entities 105.

The communications manager 1220 may support wireless communication at a network entity in accordance with examples as disclosed herein. For example, the communications manager 1220 may be configured as or otherwise support a means for determining that an energy transmitting UE is to perform a set of multiple transmissions, each transmission of the set of multiple transmissions including a data transmission, an energy transmission to charge an energy receiving device in response to a request from the energy receiving device, or both. The communications manager 1220 may be configured as or otherwise support a means for transmitting, to the energy transmitting UE and based on an energy threshold of the energy transmitting UE, one or more parameters for prioritizing the set of multiple transmissions at the energy transmitting UE.

By including or configuring the communications manager 1220 in accordance with examples as described herein, the device 1205 may support techniques for improved communication reliability, reduced latency, reduced power consumption, and more efficient utilization of communication resources.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, the processor 1235, the memory 1225, the code 1230, or any combination thereof. For example, the code 1230 may include instructions executable by the processor 1235 to cause the device 1205 to perform various aspects of prioritizing an energy request or data transmissions for EH procedures as described herein, or the processor 1235 and the memory 1225 may be otherwise configured to perform or support such operations.

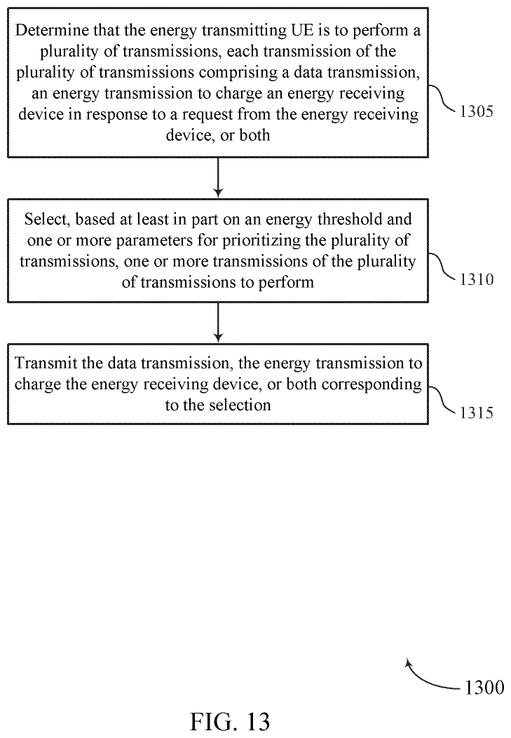

FIG. 13 shows a flowchart illustrating a method 1300 that supports prioritizing an energy request or data transmissions for EH procedures in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include determining that the energy transmitting UE is to perform a set of multiple transmissions, each transmission of the set of multiple transmissions including a data transmission, an energy transmission to charge an energy receiving device in response to a request from the energy receiving device, or both. The operations of 1305 may be performed in accordance with examples as disclosed herein. In some examples, aspects of the operations of 1305 may be performed by a determination component 725 as described with reference to FIG. 7.

At 1310, the method may include selecting, based on an energy threshold and one or more parameters for prioritizing the set of multiple transmissions, one or more transmissions of the set of multiple transmissions to perform. The operations of 1310 may be performed in accordance with examples as disclosed herein. In some examples, aspects of the operations of 1310 may be performed by a transmission selection component 730 as described with reference to FIG. 7.

At 1315, the method may include transmitting the data transmission, the energy transmission to charge the energy receiving device, or both corresponding to the selection. The operations of 1315 may be performed in accordance with examples as disclosed herein. In some examples, aspects of the operations of 1315 may be performed by a transmission component 735 as described with reference to FIG. 7.

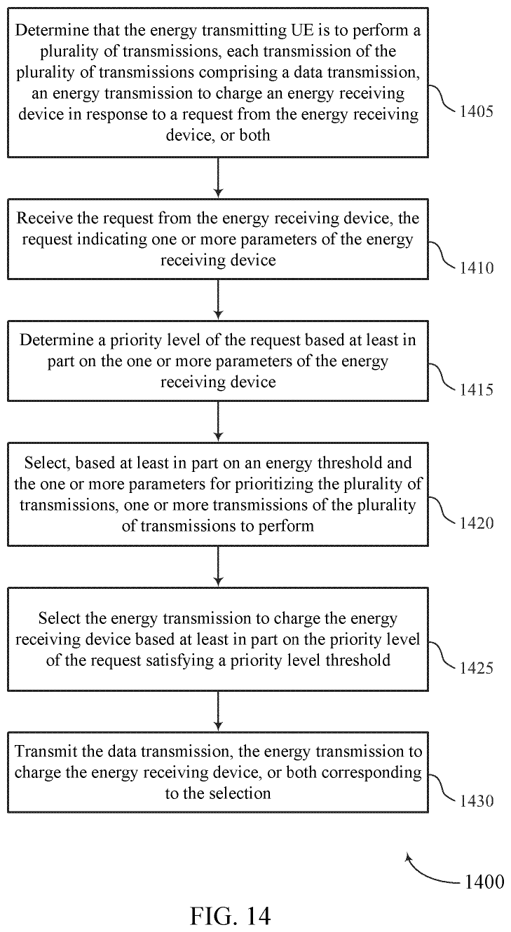

FIG. 14 shows a flowchart illustrating a method 1400 that supports prioritizing an energy request or data transmissions for EH procedures in accordance with one or more aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include determining that the energy transmitting UE is to perform a set of multiple transmissions, each transmission of the set of multiple transmissions including a data transmission, an energy transmission to charge an energy receiving device in response to a request from the energy receiving device, or both. The operations of 1405 may be performed in accordance with examples as disclosed herein. In some examples, aspects of the operations of 1405 may be performed by a determination component 725 as described with reference to FIG. 7.

At 1410, the method may include receiving the request from the energy receiving device, the request indicating one or more parameters of the energy receiving device. The operations of 1410 may be performed in accordance with examples as disclosed herein. In some examples, aspects of the operations of 1410 may be performed by a request component 740 as described with reference to FIG. 7.

At 1415, the method may include determining a priority level of the request based on the one or more parameters of the energy receiving device. The operations of 1415 may be performed in accordance with examples as disclosed herein. In some examples, aspects of the operations of 1415 may be performed by a determination component 725 as described with reference to FIG. 7.

At 1420, the method may include selecting, based on an energy threshold and the one or more parameters for prioritizing the set of multiple transmissions, one or more transmissions of the set of multiple transmissions to perform. The operations of 1420 may be performed in accordance with examples as disclosed herein. In some examples, aspects of the operations of 1420 may be performed by a transmission selection component 730 as described with reference to FIG. 7.

At 1425, the method may include selecting the energy transmission to charge the energy receiving device based on the priority level of the request satisfying a priority level threshold. The operations of 1425 may be performed in accordance with examples as disclosed herein. In some examples, aspects of the operations of 1425 may be performed by a transmission selection component 730 as described with reference to FIG. 7.

At 1430, the method may include transmitting the data transmission, the energy transmission to charge the energy receiving device, or both corresponding to the selection. The operations of 1430 may be performed in accordance with examples as disclosed herein. In some examples, aspects of the operations of 1430 may be performed by a transmission component 735 as described with reference to FIG. 7.

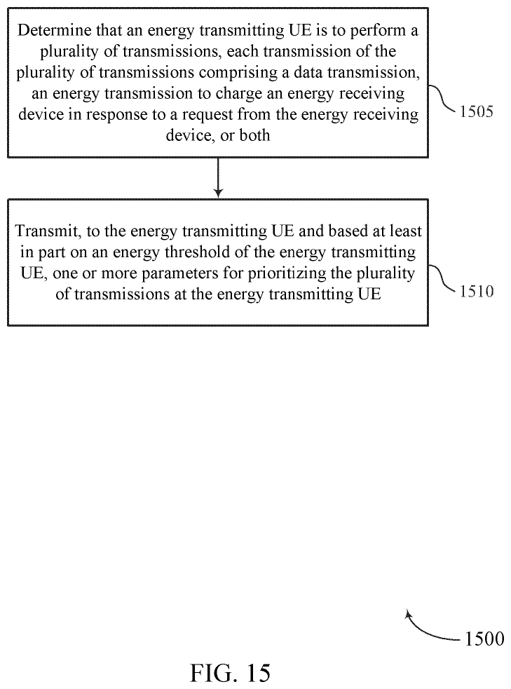

FIG. 15 shows a flowchart illustrating a method 1500 that supports prioritizing an energy request or data transmissions for EH procedures in accordance with one or more aspects of the present disclosure. The operations of the method 1500 may be implemented by a network entity or its components as described herein. For example, the operations of the method 1500 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1505, the method may include determining that an energy transmitting UE is to perform a set of multiple transmissions, each transmission of the set of multiple transmissions including a data transmission, an energy transmission to charge an energy receiving device in response to a request from the energy receiving device, or both. The operations of 1505 may be performed in accordance with examples as disclosed herein. In some examples, aspects of the operations of 1505 may be performed by a determination component 1125 as described with reference to FIG. 11.

At 1510, the method may include transmitting, to the energy transmitting UE and based on an energy threshold of the energy transmitting UE, one or more parameters for prioritizing the set of multiple transmissions at the energy transmitting UE. The operations of 1510 may be performed in accordance with examples as disclosed herein. In some examples, aspects of the operations of 1510 may be performed by a transmission component 1130 as described with reference to FIG. 11.

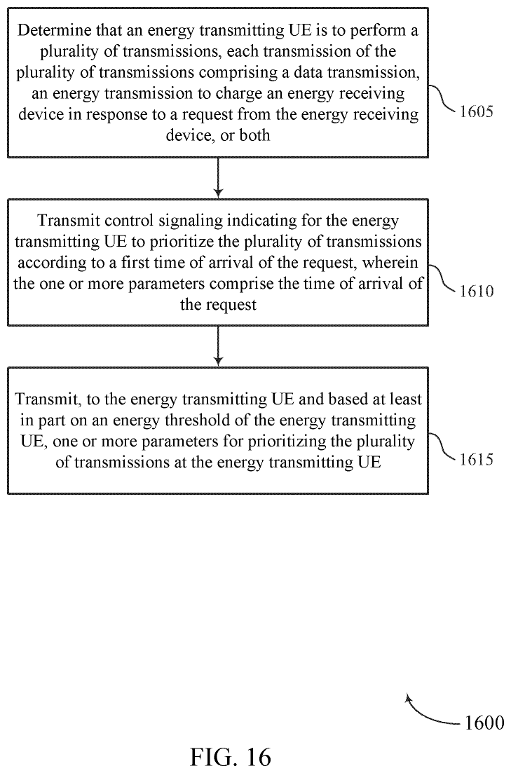

FIG. 16 shows a flowchart illustrating a method 1600 that supports prioritizing an energy request or data transmissions for EH procedures in accordance with one or more aspects of the present disclosure. The operations of the method 1600 may be implemented by a network entity or its components as described herein. For example, the operations of the method 1600 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1605, the method may include determining that an energy transmitting UE is to perform a set of multiple transmissions, each transmission of the set of multiple transmissions including a data transmission, an energy transmission to charge an energy receiving device in response to a request from the energy receiving device, or both. The operations of 1605 may be performed in accordance with examples as disclosed herein. In some examples, aspects of the operations of 1605 may be performed by a determination component 1125 as described with reference to FIG. 11.

At 1610, the method may include transmitting control signaling indicating for the energy transmitting UE to prioritize the set of multiple transmissions according to a first time of arrival of the request, where the one or more parameters include the time of arrival of the request. The operations of 1610 may be performed in accordance with examples as disclosed herein. In some examples, aspects of the operations of 1610 may be performed by a control signaling component 1135 as described with reference to FIG. 11.

At 1615, the method may include transmitting, to the energy transmitting UE and based on an energy threshold of the energy transmitting UE, one or more parameters for prioritizing the set of multiple transmissions at the energy transmitting UE. The operations of 1615 may be performed in accordance with examples as disclosed herein. In some examples, aspects of the operations of 1615 may be performed by a transmission component 1130 as described with reference to FIG. 11.

The following provides an overview of aspects of the present disclosure:

Aspect 1: A method for wireless communication at an energy transmitting UE, comprising: determining that the energy transmitting UE is to perform a plurality of transmissions, each transmission of the plurality of transmissions comprising a data transmission, an energy transmission to charge an energy receiving device in response to a request from the energy receiving device, or both: selecting, based at least in part on an energy threshold and one or more parameters for prioritizing the plurality of transmissions, one or more transmissions of the plurality of transmissions to perform; and transmitting the data transmission, the energy transmission to charge the energy receiving device, or both corresponding to the selection.

Aspect 2: The method of aspect 1, wherein selecting the one or more transmissions comprises: receiving the request from the energy receiving device, the request indicating the one or more parameters of the energy receiving device: determining a priority level of the request based at least in part on the one or more parameters of the energy receiving device; and selecting the energy transmission to charge the energy receiving device based at least in part on the priority level of the request satisfying a priority level threshold.

Aspect 3: The method of any of aspects 1 through 2, further comprising: receiving control signaling indicating for the energy transmitting UE to prioritize the plurality of transmissions according to a first time of arrival of the request, wherein the one or more parameters comprise the time of arrival of the request.

Aspect 4: The method of aspect 3, wherein selecting the one or more transmissions comprises: selecting the energy transmission to charge the energy receiving device based at least in part on the time of arrival of the request being before another time of arrival of a second request from a second energy receiving device.

Aspect 5: The method of aspect 3, wherein selecting the one or more transmissions comprises: selecting the energy transmission to charge the energy receiving device, the data transmission, or both based at least in part on the time of arrival of the request satisfying a threshold time of arrival: or selecting the data transmission based at least in part on the time of arrival of the request failing to satisfy a threshold time of arrival.

Aspect 6: The method of any of aspects 1 through 5, wherein selecting the one or more transmissions comprises: receiving an indication of a first priority of data at the energy receiving device; and selecting the one or more transmissions based at least in part on comparing the first priority of the data at the energy receiving device and a second priority of the data transmission, wherein the selecting comprises: selecting the energy transmission to charge the energy receiving device based at least in part on the first priority being greater than the second priority in accordance with the comparing: or selecting the data transmission based at least in part on the second priority being greater than the first priority in accordance with the comparing.

Aspect 7: The method of any of aspects 1 through 6, wherein selecting the one or more transmissions comprises: receiving control signaling indicating for the energy transmitting UE to prioritize the data transmission, wherein the control signaling comprises the one or more parameters; and selecting the data transmission to perform based at least in part on the control signaling.

Aspect 8: The method of any of aspects 1 through 7, wherein selecting the one or more transmissions comprises: receiving control signaling indicating for the energy transmitting UE to prioritize the data transmission, the energy transmission to charge the energy receiving device, or both, according to a prioritization schedule in a time-domain, wherein the one or more parameters comprise the prioritization schedule in the time-domain; and selecting, at an instance in the time-domain, the one or more transmissions of the plurality of transmissions to perform based at least in part on the prioritization schedule.

Aspect 9: The method of any of aspects 1 through 8, further comprising: receiving, from a network entity, control signaling indicating the one or more parameters, the energy threshold, or both.

Aspect 10: The method of any of aspects 1 through 9, further comprising: determining that transmitting the data transmission or the energy transmission to charge the energy receiving device corresponds to a first energy value less than the energy threshold; and transmitting additional energy transmission to charge an additional energy receiving device based at least in part on the energy value being less than the energy threshold, the additional signaling corresponding to a second energy value comprising a difference between the first energy value and the energy threshold.

Aspect 11: The method of aspect of any of aspects 1 through 10, wherein the one or more parameters comprise a priority of data at the energy receiving device, a remaining packet delay budget of the energy receiving device, a UE class, an energy state of the energy receiving device, a time of arrival of the request, or any combination thereof.

Aspect 12: The method of aspect 11, wherein the UE class indicates a minimum or default charging rate of the energy receiving device, a minimum or default discharge rate of the energy receiving device, a data rate of the energy receiving device, a charging technique of the energy receiving device, a harvesting architecture of the energy receiving device, a capability to harvest radio frequency energy from one or more of frequency bands, a capability to harvest from different type of energy harvesting technologies, an application monitored by the energy receiving device, or any combination thereof.

Aspect 13: The method of any of aspects 1 through 12, wherein the energy transmission comprises a repetition of the data transmission.

Aspect 14: A method for wireless communication at a network entity, comprising: determining that an energy transmitting UE is to perform a plurality of transmissions, each transmission of the plurality of transmissions comprising a data transmission, an energy transmission to charge an energy receiving device in response to a request from the energy receiving device, or both; and transmitting, to the energy transmitting UE and based at least in part on an energy threshold of the energy transmitting UE, one or more parameters for prioritizing the plurality of transmissions at the energy transmitting UE.

Aspect 15: The method of aspect 14, further comprising: transmitting control signaling indicating for the energy transmitting UE to prioritize the plurality of transmissions according to a first time of arrival of the request, wherein the one or more parameters comprise the time of arrival of the request.

Aspect 16: The method of any of aspects 14 through 15, further comprising: transmitting control signaling indicating for the energy transmitting UE to prioritize the data transmission, wherein the control signaling comprises the one or more parameters.

Aspect 17: The method of any of aspects 14 through 16, further comprising: transmitting control signaling indicating for the energy transmitting UE to prioritize the data transmission, the energy transmission to charge the energy receiving device, or both, according to a prioritization schedule in a time-domain, wherein the one or more parameters comprise the prioritization schedule in the time-domain.

Aspect 18: The method of any of aspects 14 through 17, further comprising: transmitting, to the energy transmitting UE, control signaling indicating the one or more parameters, the energy threshold, or both.

Aspect 19: The method of any of aspects 14 through 18, wherein the one or more parameters comprise a priority of data at the energy receiving device, a remaining packet delay budget of the energy receiving device, a UE class, an energy state of the energy receiving device, a time of arrival of the request, or any combination thereof.

Aspect 20: The method of aspect 19, wherein the UE class indicates a minimum or default charging rate of the energy receiving device, a minimum or default discharge rate of the energy receiving device, a data rate of the energy receiving device, a charging technique of the energy receiving device, a harvesting architecture of the energy receiving device, a capability to harvest radio frequency energy from one or more of frequency bands, a capability to harvest from different type of energy harvesting technologies, an application monitored by the energy receiving device, or any combination thereof.

Aspect 21: An apparatus for wireless communication at an energy transmitting UE, comprising a processor; memory coupled with the processor; and instructions stored in the memory and executable by the processor to cause the apparatus to perform a method of any of aspects 1 through 13.

Aspect 22: An apparatus for wireless communication at an energy transmitting UE, comprising at least one means for performing a method of any of aspects 1 through 13.

Aspect 23: A non-transitory computer-readable medium storing code for wireless communication at an energy transmitting UE, the code comprising instructions executable by a processor to perform a method of any of aspects 1 through 13.

Aspect 24: An apparatus for wireless communication at a network entity, comprising a processor: memory coupled with the processor; and instructions stored in the memory and executable by the processor to cause the apparatus to perform a method of any of aspects 14 through 20.

Aspect 25: An apparatus for wireless communication at a network entity, comprising at least one means for performing a method of any of aspects 14 through 20.

Aspect 26: A non-transitory computer-readable medium storing code for wireless communication at a network entity, the code comprising instructions executable by a processor to perform a method of any of aspects 14 through 20.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at an energy transmitting UE, comprising:
a processor;
memory coupled with the processor; and
instructions stored in the memory and executable by the processor to cause the apparatus to:
determine that the energy transmitting UE is to perform a plurality of transmissions, each transmission of the plurality of transmissions comprising a data transmission, an energy transmission to charge an energy receiving device in response to a request from the energy receiving device, or both;
select, based at least in part on an energy threshold and one or more parameters for prioritizing the plurality of transmissions, one or more transmissions of the plurality of transmissions to perform; and
transmit the data transmission, the energy transmission to charge the energy receiving device, or both corresponding to the selection.

2. The apparatus of claim 1, wherein the instructions to select the one or more transmissions are executable by the processor to cause the apparatus to:
receive the request from the energy receiving device, the request indicating the one or more parameters of the energy receiving device;
determine a priority level of the request based at least in part on the one or more parameters of the energy receiving device; and
select the energy transmission to charge the energy receiving device based at least in part on the priority level of the request satisfying a priority level threshold.

3. The apparatus of claim 1, wherein the instructions are further executable by the processor to cause the apparatus to:
receive control signaling indicating for the energy transmitting UE to prioritize the plurality of transmissions according to a first time of arrival of the request, wherein the one or more parameters comprise the time of arrival of the request.

4. The apparatus of claim 3, wherein the instructions to select the one or more transmissions are executable by the processor to cause the apparatus to:
select the energy transmission to charge the energy receiving device based at least in part on the time of arrival of the request being before another time of arrival of a second request from a second energy receiving device.

5. The apparatus of claim 3, wherein the instructions to select the one or more transmissions are executable by the processor to cause the apparatus to:
select the energy transmission to charge the energy receiving device, the data transmission, or both based at least in part on the time of arrival of the request satisfying a threshold time of arrival; or
select the data transmission based at least in part on the time of arrival of the request failing to satisfy a threshold time of arrival.

6. The apparatus of claim 1, wherein the instructions to select the one or more transmissions are executable by the processor to cause the apparatus to:
receive an indication of a first priority of data at the energy receiving device; and
select the one or more transmissions based at least in part on comparing the first priority of the data at the energy receiving device and a second priority of the data transmission, wherein the selecting comprises:
select the energy transmission to charge the energy receiving device based at least in part on the first priority being greater than the second priority in accordance with the comparing: or
select the data transmission based at least in part on the second priority being greater than the first priority in accordance with the comparing.

7. The apparatus of claim 1, wherein the instructions to select the one or more transmissions are executable by the processor to cause the apparatus to:
receive control signaling indicating for the energy transmitting UE to prioritize the data transmission, wherein the control signaling comprises the one or more parameters; and
select the data transmission to perform based at least in part on the control signaling.

8. The apparatus of claim 1, wherein the instructions to select the one or more transmissions are executable by the processor to cause the apparatus to:
receive control signaling indicating for the energy transmitting UE to prioritize the data transmission, the energy transmission to charge the energy receiving device, or both, according to a prioritization schedule in a time-domain, wherein the one or more parameters comprise the prioritization schedule in the time-domain; and
select, at an instance in the time-domain, the one or more transmissions of the plurality of transmissions to perform based at least in part on the prioritization schedule.

9. The apparatus of claim 1, wherein the instructions are further executable by the processor to cause the apparatus to:
receive, from a network entity, control signaling indicating the one or more parameters, the energy threshold, or both.

10. The apparatus of claim 1, wherein the instructions are further executable by the processor to cause the apparatus to:
determine that transmitting the data transmission or the energy transmission to charge the energy receiving device corresponds to a first energy value less than the energy threshold; and
transmit additional energy transmissions to charge an additional energy receiving device based at least in part on the energy value being less than the energy threshold, the additional energy transmissions corresponding to a second energy value comprising a difference between the first energy value and the energy threshold.

11. The apparatus of claim 1, wherein the one or more parameters comprise a quality of service value of data associated with the energy receiving device, priority of data associated with the energy receiving device, a remaining packet delay budget of data associated with the energy receiving device, a current quality of service associated with charging the energy receiving device, a current transmit data rate condition associated with the energy receiving device, a current receive data rate condition associated with the energy receiving device, a UE class, an energy state of the energy receiving device, a current charging rate associated with the energy receiving device, a current discharging rate associated with the energy receiving device, a time of arrival of the request, or any combination thereof.

12. The apparatus of claim 11, wherein the UE class indicates a minimum or default charging rate of the energy receiving device, a minimum or default discharge rate of the energy receiving device, a transmit data rate of the energy receiving device, a receive data rate of the energy receiving device, a quality of service condition associated with charging the energy receiving device, a charging technique of the energy receiving device, a harvesting architecture of the energy receiving device, a capability to harvest radio frequency energy from one or more of frequency bands, a capability to harvest from different type of energy harvesting technologies, an application monitored by the energy receiving device, or any combination thereof.

13. The apparatus of claim 1, wherein the energy transmission comprises a repetition of the data transmission.

14. An apparatus for wireless communication at a network entity, comprising:
a processor:
memory coupled with the processor; and
instructions stored in the memory and executable by the processor to cause the apparatus to:
determine that an energy transmitting user equipment (UE) is to perform a plurality of transmissions, each transmission of the plurality of transmissions comprising a data transmission, an energy transmission to charge an energy receiving device in response to a request from the energy receiving device, or both; and
transmit, to the energy transmitting UE and based at least in part on an energy threshold of the energy transmitting UE, one or more parameters for prioritizing the plurality of transmissions at the energy transmitting UE.

15. The apparatus of claim 14, wherein the instructions are further executable by the processor to cause the apparatus to:
transmit control signaling indicating for the energy transmitting UE to prioritize the plurality of transmissions according to a first time of arrival of the request, wherein the one or more parameters comprise the time of arrival of the request.

16. The apparatus of claim 14, wherein the instructions are further executable by the processor to cause the apparatus to:
transmit control signaling indicating for the energy transmitting UE to prioritize the data transmission, wherein the control signaling comprises the one or more parameters.

17. The apparatus of claim 14, wherein the instructions are further executable by the processor to cause the apparatus to:
transmit control signaling indicating for the energy transmitting UE to prioritize the data transmission, the energy transmission to charge the energy receiving device, or both, according to a prioritization schedule in a time-domain, wherein the one or more parameters comprise the prioritization schedule in the time-domain.

18. The apparatus of claim 14, wherein the instructions are further executable by the processor to cause the apparatus to:
transmit, to the energy transmitting UE, control signaling indicating the one or more parameters, the energy threshold, or both.

19. The apparatus of claim 14, wherein the one or more parameters comprise a quality of service value of data associated with the energy receiving device, priority of data associated with the energy receiving device, a remaining packet delay budget of data associated with the energy receiving device, a current quality of service associated with charging the energy receiving device, a current transmit data rate condition associated with the energy receiving device, a current receive data rate condition associated with the energy receiving device, a UE class, an energy state of the energy receiving device, a current charging rate associated with the energy receiving device, a current discharging rate associated with the energy receiving device, a time of arrival of the request, or any combination thereof.

20. The apparatus of claim 19, wherein the UE class indicates a minimum or default charging rate of the energy receiving device, a minimum or default discharge rate of the energy receiving device, a transmit data rate of the energy receiving device, a receive data rate of the energy receiving device, a quality of service condition associated with charging the energy receiving device, a charging technique of the energy receiving device, a harvesting architecture of the energy receiving device, a capability to harvest radio frequency energy from one or more of frequency bands, a capability to harvest from different type of energy harvesting technologies, an application monitored by the energy receiving device, or any combination thereof.

21. A method for wireless communication at an energy transmitting UE, comprising:
determining that the energy transmitting UE is to perform a plurality of transmissions, each transmission of the plurality of transmissions comprising a data transmission, an energy transmission to charge an energy receiving device in response to a request from the energy receiving device, or both;
selecting, based at least in part on an energy threshold and one or more parameters for prioritizing the plurality of transmissions, one or more transmissions of the plurality of transmissions to perform; and
transmitting the data transmission, the energy transmission to charge the energy receiving device, or both corresponding to the selection.

22. The method of claim 21, wherein selecting the one or more transmissions comprises:
receiving the request from the energy receiving device, the request indicating the one or more parameters of the energy receiving device:
determining a priority level of the request based at least in part on the one or more parameters of the energy receiving device; and
selecting the energy transmission to charge the energy receiving device based at least in part on the priority level of the request satisfying a priority level threshold.

23. The method of claim 21, further comprising:
receiving control signaling indicating for the energy transmitting UE to prioritize the plurality of transmissions according to a first time of arrival of the request, wherein the one or more parameters comprise the time of arrival of the request.

24. The method of claim 21, wherein selecting the one or more transmissions comprises:
receiving an indication of a first priority of data at the energy receiving device; and
selecting the one or more transmissions based at least in part on comparing the first priority of the data at the energy receiving device and a second priority of the data transmission, wherein the selecting comprises:
selecting the energy transmission to charge the energy receiving device based at least in part on the first priority being greater than the second priority in accordance with the comparing: or
selecting the data transmission based at least in part on the second priority being greater than the first priority in accordance with the comparing.

25. The method of claim 21, wherein selecting the one or more transmissions comprises:
receiving control signaling indicating for the energy transmitting UE to prioritize the data transmission, wherein the control signaling comprises the one or more parameters; and
selecting the data transmission to perform based at least in part on the control signaling.

26. A method for wireless communication at a network entity, comprising:
determining that an energy transmitting user equipment (UE) is to perform a plurality of transmissions, each transmission of the plurality of transmissions comprising a data transmission, an energy transmission to charge an energy receiving device in response to a request from the energy receiving device, or both; and
transmitting, to the energy transmitting UE and based at least in part on an energy threshold of the energy transmitting UE, one or more parameters for prioritizing the plurality of transmissions at the energy transmitting UE.

27. The method of claim 26, further comprising:
transmitting control signaling indicating for the energy transmitting UE to prioritize the plurality of transmissions according to a first time of arrival of the request, wherein the one or more parameters comprise the time of arrival of the request.

28. The method of claim 26, further comprising:
transmitting control signaling indicating for the energy transmitting UE to prioritize the data transmission, wherein the control signaling comprises the one or more parameters.

29. The method of claim 26, further comprising:
transmitting control signaling indicating for the energy transmitting UE to prioritize the data transmission, the energy transmission to charge the energy receiving device, or both, according to a prioritization schedule in a time-domain, wherein the one or more parameters comprise the prioritization schedule in the time-domain.

30. The method of claim 26, further comprising:
transmitting, to the energy transmitting UE, control signaling indicating the one or more parameters, the energy threshold, or both.
